(19) United States
(12) Patent Application Publication
(10) Pub. No.: US 2019/0019251 A1
(43) Pub. Date: Jan. 17, 2019

(54) INVESTMENT CARD

(71) Applicant: Innovative Card Systems Inc., Houston, TX (US)

(72) Inventor: Frederick Paul Phillips, IV, Houston, TX (US)

(21) Appl. No.: 16/008,861

(22) Filed: Jun. 14, 2018

Related U.S. Application Data
(63) Continuation of application No. 14/436,007, filed on Apr. 15, 2015, now abandoned.
(60) Provisional application No. 61/714,487, filed on Oct. 16, 2012.

(51) Int. Cl. G06Q 40/04; G06Q 40/06; G06Q 20/10; G06Q 20/34

(52) U.S. Cl. CPC G06Q 40/04; G06Q 20/34; G06Q 20/10; G06Q 40/06

(57) ABSTRACT

In various embodiments, processes, methods, tools, strategies, and techniques are provided for linking an investment card to an investment card account including one or more securities or other assets. At least one value associated with the investment card can be linked to the value of a security within the investment card account. The investment card can be employed in a variety of transactions, such as purchase transactions involving products or services.

### BACKGROUND

Securities are a popular form of investment because as an asset class they can generate positive returns over time. However, problems inhere in the costs and complications of buying and selling securities, which can make it cumbersome and expensive to use securities to fund frequent purchases of products or services. Usually the investor must determine how much to spend for a transaction, sell an amount of securities corresponding to the transaction price, transfer the security sale proceeds to a cash account, and then use the funds in the cash account to pay for the purchase. If during this long chain of events the security has increased in value, however, then the investor can lose the value of any such increase.

In view of these issues, enhanced processes, methods, tools, strategies, and techniques are needed for linking an investment card to an investment card account, so that optimum use of the assets contained in the investment card account can be achieved in connection with various transactions.

### BRIEF DESCRIPTION OF THE FIGURES

The utility of the embodiments of the invention will be readily appreciated and understood from consideration of the following description of the embodiments of the invention when viewed in connection with the accompanying drawings. The accompanying drawings, which are included as part of the present specification, illustrate the presently preferred embodiment and, together with the general description given above and the detailed description of the preferred embodiment given below, serve to explain and teach the principles of the present invention.

FIG. 1 illustrates various aspects of an example of a system architecture and process flow provided in accordance with various embodiments of the invention;

FIG. 2 illustrates certain aspects of FIG. 1 in more detail;

FIG. 3A illustrates an example of a process flow provided in accordance with various embodiments of the invention;

FIG. 3B illustrates various aspects of an example of a system architecture and process flow provided in accordance with various embodiments of the invention;

FIG. 4 illustrates an example of a process flow provided in accordance with various embodiments of the invention;

FIG. 5 illustrates an example of a system architecture provided in accordance with various embodiments of the invention;

FIGS. 6 through 9 include screen displays illustrating examples of user interfaces that may be displayed to a cardholder in accordance with various embodiments of the invention; and,

FIG. 10 illustrates various aspects of an example of a system architecture and process flow provided in accordance with various embodiments of the invention.

It should be noted that the figures are intended to facilitate the description of the various embodiments described herein. The figures do not necessarily describe every aspect of the teachings disclosed herein and do not necessarily limit the scope of the claims.

### DESCRIPTION

In various embodiments, the invention relates to processes, methods, tools, strategies, and techniques for linking an investment card to an investment card account comprised of securities, cash, and/or other assets. The investment card can be employed in a variety of transactions, such as purchase transactions involving products or services provided by a merchant.

The terms “card” or “investment card” have been used herein for convenience of disclosure. It can be appreciated that the investment card transactions described herein may be conducted not only with physical, tangible plastic cards (e.g., traditional debit cards, credit cards, prepaid cards, etc.), but also with other interfaces or applications (e.g., smart phones which may communicate with a payment terminal via Near Field Communication (NFC) standards or alternative standards). For example, a smart phone or mobile phone can be programmed to allow one or more of a variety of virtual cards and/or one or more wallets on such cards to be selected, accessed, and/or applied to a transaction. A “card” as applied to various embodiments of the invention may be physical, virtual, or activated through another type of suitable application or interface.

In certain aspects, the value of an investment card can be linked to the value of a security. This allows the cardholder to maintain funds invested in a securities portfolio, while having the intrinsic convenience and cost savings of being able to spend such funds directly via an open loop or closed loop investment card. For purposes of this document, the term “security” may refer to a single security, a portfolio of securities, or a single security or portfolio of securities combined with cash. The invention may be embodied as a hybrid investment and spending instrument, since the investment cardholder is able to maintain funds invested in a given security until a purchase is made with the card, at which time all or a portion of the underlying security is sold in an amount necessary to pay for such expenditure.

Various embodiments of the invention can provide numerous benefits in view of other solutions. Rather than a traditional credit card, debit card, or prepaid card tied to a cash account that in turn is tied to physical possession of a commodity (e.g., gold), which in turn serves as collateral for the card, embodiments of the present invention by contrast contemplate an investment card directly linked to a security. In certain embodiments, the holder of the investment card may have funds directly invested in a security or securities of choice, and expenditures can be financed by the direct purchase and sale of these securities. Thus, embodiments of the invention do not necessarily require the cardholder to place any collateral with the financial institution, nor to obtain a credit card, debit card, or prepaid card tied to such collateral. However, in one example, the cardholder could use collateral such as equity derived from a home equity loan or line of credit as a source for funding an investment card with securities, cash, or other assets.

In certain embodiments, the invention offers features that are absent in prior solutions and which arise from the fact that cardholder investments are held in securities rather than cash. More specifically, previous solutions typically have the financial institution issue a credit card, debit card, or prepaid card whose value is held in cash, which in turn enables such cards to rely on traditional cash-to-cash processing. By contrast, embodiments of the present invention relate to the card network (e.g., American Express, Discover, MasterCard, and/or Visa) and the transaction processor receiving data feeds regarding the price of a security, and based upon said price and the parameters defined by the relevant party (e.g., the card issuer), deciding whether or not to authorize a purchase with the investment card.

In various embodiments, tools and techniques are provided wherein a relevant party (e.g., the card issuer) can define algorithms to define the spending parameters of the investment card—again, a feature specified because the cardholder's investments are held in securities rather than cash. More specifically, as the value of a security frequently fluctuates, the card issuer has the option of differentiating between the market value of the investment cardholder's account and the percentage of those funds that are available for expenditure. In certain embodiments, the investment cardholder and/or the card issuer can define algorithms to automatically reconfigure the investment portfolio, such as when certain performance metrics (e.g., absolute or relative value of a security, or the volatility of a security) move outside of a defined minimum or maximum range. Furthermore, the investment cardholder and/or the card issuer can be permitted to define algorithms to automatically liquidate holdings if certain parameters are exceeded. Various embodiments of the invention provide algorithms regarding the relationship between the value of the cardholder's security account and the funds he has available to spend at any given time. Systems, methods, tools, and techniques are provided wherein a card issuer and/or transaction processor can establish algorithms regarding the relationship between the value of the cardholder investment card account and funds available to spend that potentially limit exposure and risk for the card issuer.

For example, the card issuer can evaluate the volatility of the security linked to the card to define parameters regarding what percentage of invested funds the cardholder is able to spend. Thus, the card issuer may allow a cardholder who links his card to a high beta security (e.g., a highly volatile stock) access to a lower percentage of the portfolio value than a cardholder who links the card to a comparatively low beta security (e.g., a general stock market index). The beta (β) of a given security is a numerical value that quantifies the correlated volatility of such security in relation to the volatility of a defined benchmark. The assumed value of that benchmark is typically estimated via a given macro market index such as the S&P 500. The formula for the beta of an asset within a portfolio is

$${β}_{a} = \frac{Cov ( {r}_{a} , {r}_{p} )}{Var ( {r}_{p} )} ,$$

where rₐ measures the rate of return of the asset, rₚ measures the rate of return of the portfolio, and cov (rₐ, rₚ) is the covariance between the rates of return. Thus, a beta of more than 1 indicates that the security's price will be more volatile than the macro market. For example, if a stock's beta is 1.2, theoretically it is 20% more volatile than the market. Many utilities stocks have a beta less than 1 while many tech stocks have a beta greater than 1, offering a chance for higher returns but with greater risk.

Unlike credit cards (which are a cash loan from the card issuer that the cardholder promises to repay), prepaid cards (which are cards that are preloaded with the cardholder's cash), or debit cards (which are cards linked to the cardholder's cash account), the investment card provided herein is not tied to a cash account but instead is tied to an investment card account comprised primarily of securities instead of cash. More specifically, the investment card can be linked directly to the performance of a security, so that rather than having a static balance comprised of cash the investment card has a dynamic balance that reflects the underlying price movements of the linked security or securities. An investment card may eliminate the onerous costs and fees associated with credit, prepaid, and debit cards. Furthermore, the investment card may eliminate the problem of having traditional accounts linked to cash; because cash can generate negative returns over time, there is a meaningful opportunity cost to maintaining cash accounts to fund routine purchases, and the investment card obviates such opportunity cost.

Therefore, it would be advantageous to combine investment and spending in a single instrument. An investment card linked to a security can provide the benefits of investing in securities while at the same time providing the ease and convenience of being able to directly spend those funds via an open or closed loop card. Simultaneously, purchases made by the investment card can be processed. Unlike current credit, prepaid, or debit cards—where the purchase amount is simply paid from a cash account—embodiments of the invention take a novel approach to data processing combining technical applications and algorithms regarding the relationship between the value of the cardholder account and the funds available to spend at any given time. Because (unlike cash) the value of a given security may be in a frequent state of flux, innovative quantitative models can be used to define the spending parameters for the investment card.

In various embodiments, the cardholder may be able to choose any preferred security, and the value of the card can be automatically linked to the performance of the selected security portfolio. If, for example, the cardholder chooses to link the card to the performance of shares in General Motors, then the cardholder will transfer cash directly or indirectly to the card issuer, instruct the card issuer to purchase shares of General Motors for his account, and the card issuer will take the funds and directly or indirectly purchase such shares. The funds available on the investment card will then rise and fall in accordance with the price movement of such security, and the security will be transferred or sold as, when, and in amounts needed to cover cardholder expenditures. Accordingly, the cardholder can have the full benefit of the selected investment until the moment the card is used—and there is a reduction in the cost, inconvenience, and uncertainty inherent in having to separately maintain an investment account and an exclusively cash account to pay for credit card, prepaid card, or debit card purchases.

It can be seen that an investment card can be styled or structured to function in accordance with many of the characteristics of a debit card, prepaid card, or credit card. For example, the investment card may be preloaded with a certain number of shares of a security and given to a recipient as a gift card. In this situation, the investment card could be considered a species of prepaid card. In another example, the investment card could be linked to a margin account, making the investment card behave like a type of credit card.

In various embodiments, processes or transactions involving an investment card may include linking the card network (e.g., MasterCard), the transaction processor, the investment cardholder, the merchant, the investment card issuing bank, the merchant bank, and/or a data stream (e.g., from a stock exchange and, if the transaction currency and investment card denominated currencies are different, a foreign currency exchange) that provides information regarding the value of the security/securities linked to the investment card. This enables the transaction to be evaluated for authorization and, if approved, instructs the investment card issuer regarding the amount of securities to be sold to pay for the transaction. In addition, processes involving the investment card recognize the relationship between the currency in which the card is denominated and the currency in which the transaction is denominated.

In addition, in various embodiments, an issuer of the investment card may be able to internally cross trades between accounts adding funds by selling securities and accounts spending funds to buy securities, for example. The card issuer may be able to offset the inflow and outflow of funds for a specific security linked to multiple investment cards, for example, thereby attaining greater efficiencies by reducing both the number and size of trades. In various embodiments, the card issuer can internally cross trades between those adding and those spending funds on investment cards linked to the same security—again, a feature that arises from the fact that the cardholder investments are held in securities rather than cash. Rather than executing buy and sell orders each time an investment cardholder adds funds to or makes an expenditure with his card, the card issuer may aggregate all buy and sell orders over a defined time interval, for example, cross out the corresponding amounts, and then make a single trade to rectify any imbalance.

In various embodiments, systems and methods are provided for one relevant party—e.g., the investment cardholder, the card issuer, the processor, the network, and/or the merchant—to communicate with another relevant party. These communications may include, but are not limited to, communications regarding transactions, card loads and/or portfolio reconfiguration, the nominal value of the investment card and the funds available for expenditure on the investment card, and the performance of the security/securities on the investment card relative to different metrics such as absolute performance, relative performance, and beta values.

FIGS. 1 through 3B illustrate various aspects of examples of processing data and transactions associated with an investment card 102 as structured in accordance with various embodiments of the invention. The investment card 102 may be structured for use by a cardholder 104 by a financial institution 106. For example, the financial institution 106 may be a retail bank, an investment bank, a mutual fund company, or other entities that typically issue prepaid cards, debit cards or credit cards to cardholders 104 for making purchase transactions or other transactions involving products or services. Structuring the investment card 102 includes establishing an investment card account 108 through the financial institution 106, at step 302. Establishing the investment card account 108 may include funding the investment card account 108 with at least one security 108A, cash 108B, and/or other assets 108C, at step 304. The investment card account 108 may include one or more accounts wherein various securities may be bought, sold, and/or converted into other assets. In certain embodiments, the investment card account 108 may be a margin account or a cash account, for example, and/or may be associated with a mutual fund account. Funding the investment card 102 may then be accomplished by linking a value of at least one security 108A in the established investment card account 108 to at least one value associated with the investment card 102. In operation, at least part of the value associated with the investment card 102 can be applied in association with the value or purchase price of a transaction involving products or services, for example. It can be seen that linking the investment card account 108 to the investment card 102 may result in changes or fluctuations in the value of the investment card 102 which is available to be applied to different transactions.

At step 306, various aspects of the investment card 102 can be configured to include a variety of different features. For example, at step 306A, one or more aspects of the architecture of the card 102 may be structured. Such aspects may include enumerating the number and type of wallets 102A associated with the card 102, selecting a currency or currencies in which to denominate one or more wallets of the card 102, and/or determining a composition of assets 108A-108C from the investment card account 108 to link with the card 102. Also, in certain embodiments, one or more kinds of credit cards 102B, prepaid cards 102C, and/or debit cards 102D (and their associated accounts) may be linked to the investment card 102. Such cards 102B, 102C, 102D may be considered supplemental wallet types which represent examples of supplemental wallets that can be operatively associated with the investment card 102. For example, in certain circumstances the financial institution 106 may approve a purchase transaction even though there may be insufficient funds in the investment card account 108 to cover the purchase. It can be seen that links to such cards 102B-102D can provide protection against an investment card 102 overdraft condition (e.g., when the value of the securities 108A associated with the card 102 is insufficient to cover full payment of a purchase). In certain embodiments, with respect to algorithms that determine a priority or hierarchy for selecting or accessing a wallet from among a plurality of wallets, any relevant supplemental wallets may also be considered for selection or access in accordance with executing the algorithm.

At step 306B, one or more algorithms may be configured to operate in connection with the investment card account 108 such as for determining a funds available value associated with the investment card 102, for determining a hierarchy or priority by which multiple wallets of the card 102 are accessed, and/or for determining a hierarchy or priority by which different assets 108A-108C are applied, redeemed, purchased, or converted in connection with using the card 102. In various embodiments, one or more payment algorithms can be configured by the financial institution 106 and/or the cardholder 104 to govern the relationship between the value of the investment card account 108 and funds available on the investment card 102 for different transactions. In certain embodiments, one or more wallet algorithms may be structured to determine the hierarchy by which multiple wallets associated with the card 102 will be accessed (if the investment card 102 has more than one wallet). At step 306C, one or more alerts or notifications associated with the investment card 102, the investment card account 108, and/or the assets 108A-108C can be configured for communication through a variety of communication media and/or access devices.

At step 308, the card can be activated by the financial institution 106 for use by the cardholder 104 in connection with various tasks or transactions. At step 310, the investment card 102 may be involved in different tasks or transactions related to the investment card account 108, the assets 108A-108C, and/or transactions with various merchants 110 or other product/service providers. For example, at step 310A, a particular wallet or wallets may be selected for use in conjunction with a given transaction, such as if the transaction involves a certain foreign currency and the wallet is selected to correspond to that foreign currency. At step 310B, one or more of the assets 108A-108C can be applied to the transaction, such as in accordance with one or more algorithms configured for execution in connection with using the card 102. In another example, at step 310C, data related to transactions involving the card 102 may be communicated to or from various entities surrounding the transaction. Such communications may include alerts or notifications, for example, sent to the cardholder 104 regarding how the assets 108A-108C have been applied to handle a particular transaction. At step 310D, rather than immediately executing an algorithm such as a payment algorithm in connection with a transaction, processing of the transaction may be held or suspended pending communication of additional information, such as the results of a fraud analysis or waiting for a securities 108A trade to be effectuated or sales proceeds received, for example.

It can be seen that the investment card 102 can be linked to one or more securities 108A through the financial institution 106 and funded according to certain embodiments of the invention. In an example of one scenario, the cardholder 104 transfers cash 108B into the account 108 at the financial institution 106. The cardholder 104 then obtains an investment card 102 linked to the investment card account 108. The cardholder 104 may then choose the security or securities 108A in which to invest and the financial institution 106 can be instructed to purchase such securities 108A for the account 108. As noted above, the account 108 may be comprised of both securities 108A and cash 108B, among other types of assets 108C. The cardholder 104 may also specify whether or not multiple wallets are desired for the card 102. In the case of multiple wallets, the cardholder 104 can select the underlying security or securities for each wallet, as well as the currency denomination for each wallet.

For example, security holdings 108A in the account 108 may be converted into other securities 108A or cash 108B in accordance with an algorithm, and an algorithm may determine in the context of a hybrid security-cash account 108 the hierarchy by which funds are accessed. One or more entities—such as the cardholder 104, the card issuer 106, and/or the card processor 116—can establish algorithms to determine what percentage of the value in the account 108 is available for expenditure. Various embodiments of the invention address the problem of how to decide whether to authorize a given expenditure when the value of the security or securities 108A linked to the card 102, and therefore the value of the account 108, may be in a state of flux.

In various embodiments, one or more algorithms may be applied for determining the funds available in the investment card account 108 for transactions. The funds available value may be determined in response to one or more performance metrics associated with one or more securities of the investment card account 108 or the investment card account 108 itself, such as an aggregate value associated with the account 108. An algorithm may be executed to automatically adjust certain aspects of the investment card account 108 in response to one or more performance metrics such as beta value, minimum beta value, maximum beta value, asset value gain, or asset value loss, among many others. Another algorithm may automatically convert a security 108A associated with the investment card account 108 to at least one other type of asset 108A-108C at a predetermined level of a selected performance metric of the security 108A in connection with a predetermined period (e.g., day, month, quarter, etc.). Conversion of securities 108A may be executed in response to transaction data, such as transactions involving the purchase of a product or service.

In various embodiments, the investment card account 108 may be adjusted in different ways in response to execution of certain algorithms. Such adjustments may include, for example, security-to-security conversion, cash-to-security conversion, or security-to-cash conversion. In certain embodiments, an investment strategy may be adjusted for the account 108, wherein such strategies can include a conservative strategy, a moderate strategy, or an aggressive strategy, or other strategies that dictate how to buy, sell, or use assets 108A-108C within the account 108. In another example, an algorithm may be configured for automatically converting an amount of cash 108E associated with the investment card account 108 to at least one other type of asset 108A-108C at a predetermined level of a selected performance metric in connection with a predetermined period. In certain embodiments, an algorithm may be executed to adjust the investment card account 108 in accordance with an asset redemption hierarchy such as by applying funds of the investment card account 108 to a purchase transaction in accordance with the asset redemption hierarchy, for example. In various embodiments, the asset redemption hierarchy can be configured to select one or more securities 108A, for example, for redemption from among multiple securities 108A associated with the same card 102, or from among multiple securities 108A associated with multiple cards 102. In other words, the asset redemption hierarchy can be executed to fund a transaction based on a fixed or predetermined prioritization of the securities 108A associated with a single card 102 having multiple wallets, for example, or perhaps multiple cards 102 wherein each card 102 of the multiple cards 102 is associated with one security 108A. In certain embodiments, the asset redemption hierarchy may employ one or more performance metrics, and/or a predetermined order of redemption, to determine which security 108A or other assets 108C to apply to a given transaction.

As noted above, a card 102 can be comprised of multiple wallets, whereby each individual wallet combined on the card 102 can comprise multiple securities 108A and cash 108B. An algorithm can be applied to determine the hierarchy by which the various wallets are accessed (e.g., a fixed order, best performing first, worst performing first, etc.). Each wallet may be linked to at least one of a security 108A value or a cash 108B value, and an algorithm may be executed for determining which wallet of the plurality of wallets to access in connection with an investment card 102 transaction. Accessing one or more of the wallets may occur in connection with a wallet access hierarchy, such as by first accessing a wallet having a performance metric worse than or better than a performance metric of another wallet. Successive wallets may be accessed for the same transaction as needed to satisfy a purchase price associated with the transaction, for example.

In certain passive embodiments, various algorithms can be provided that follow a set of rules or heuristics that lead to a default decision regarding which wallet is used for a given transaction. In other active embodiments, the cardholder 104 may be allowed to specify one or more wallets to access and use for a given transaction. For example, if there are two wallets on the card 102 (e.g., one funded with GM stock, and the other funded with Ford stock), then the cardholder 104 may be permitted to actively specify at the time of a transaction which wallet to use for the transaction. In another example, the multiple wallet configuration may be supplemented or replaced with multiple cards 102, wherein each card 102 is linked to one or more securities 108A. In this example, one or more individual cards 102 can be selected from among the multiple cards 102 for use in connection with the transaction.

In certain embodiments, values associated with different wallets may be denominated in different currencies. An algorithm may be executed for accessing a wallet having a currency corresponding to a currency associated with a particular transaction, for example. In another example, an algorithm may be executed for accessing a wallet when there is no wallet having a currency corresponding to the currency associated with the transaction. In another example, an algorithm may be executed when it is determined that there is no wallet with sufficient funds in the currency corresponding to the currency associated with the transaction. In certain embodiments, determining the funds available value for a wallet may be executed in response to one or more performance metrics associated with one or more securities 108A in a selected wallet, or in response to an aggregate value of the plurality of wallets. In one example, an algorithm may be configured for automatically converting a security 108A associated with at least one wallet to at least one other type of asset 108A-108C at a predetermined level of a selected performance metric of the security 108A in connection with a predetermined period. In another example, an amount of cash 108B associated with a wallet may be converted to at least one other type of asset 108A-108C, if a predetermined asset value loss or asset value gain is experienced by the investment card account 108 during a predetermined period.

In certain embodiments, a transaction history associated with use of the investment card 102 can be generated. In one example, an asset conversion history associated with the investment card account 108 can be generated and displayed. In other examples, a current portfolio configuration and/or a portfolio reconfiguration history for the investment card account 108 can be generated. In various embodiments, alerts or notifications may be communicated regarding transactions involving different aspects of the investment card 102 or the investment card account 108, such as in response to any transaction involving at least a predetermined portion of an aggregate value of the investment card account 108; in response to a security 108A purchase or security 108A redemption; in response to a currently available funds value falling below a predetermined portion of an initially available funds value associated with the investment card account 108; and/or, in response to a currently available funds value falling below a predetermined portion of a nominal value associated with the investment card account 108, among others. Alerts or notifications may be communicated through various communication media such as an electronic mail medium, an electronic text message medium, and/or a mobile phone related medium.

Upon initially opening the account 108, the cardholder 104 may be asked certain questions or asked to set certain parameters for the investment card 102 including, for example: Is a single wallet or are multiple wallets desired for the investment card 102? What currency should denominate the one or more wallets on the investment card 102? What security or securities—and in what amount—should be linked to each wallet on the investment card 102? What automatic or manual algorithms, rules, or other heuristics are desired to reconfigure the portfolio represented by the asset holdings 108A-108C in the account 108? What alerts or other notifications are desired to be communicated regarding activity or transactions involving the investment card 102? How would the cardholder 104 like to modify the investment card 102: by transferring funds onto or from the investment card 102, or by adding or eliminating wallets on the card 102? In the case of multiple wallets, what security or securities 108A would the cardholder 104 like to add or remove from the different wallets? The financial institution 106 may then use cash funds of the cardholder 104 to purchase the chosen securities 108A and place such securities 108A in the investment card account 108. As the value of the securities 108A and/or other assets 108C increase or decrease, the balance on the investment card 102 can change accordingly. The financial institution 106 can sell or redeem the securities 108A in the account 108 as necessary to pay for cardholder 104 expenditures involving the investment card 102. When there are no more securities 108A or other assets 108C remaining in the account 108, then the cardholder 104 may not be permitted to make further expenditures unless and until additional funds are added to the account 108.

In one scenario, the cardholder 104 obtains the investment card 102 from the card issuer 106 that holds his account 108. The card issuer 106 may directly or indirectly be a BIN (Bank Identification Number) sponsor or program manager. The card 102 may be closed loop, so that it can only be used at a limited group of merchants 110 (and their associated banks 112); or the card may be open loop or a general purpose card that operates, for example, on American Express, Discover, MasterCard, Visa, or similar card networks 114 and can be used wherever those cards are accepted. During a transaction, the cardholder 104 presents the investment card 102 to the merchant 110 to effectuate payment. If the card is open loop, then the transaction authorization is routed via the relevant network to the card processor or transaction processor 116. The transaction processor 116 determines whether the investment card 102 is valid and whether sufficient funds are available; if not, the cardholder 104 must use another form of payment or cancel the transaction. The transaction processor 116 obtains data feeds regarding the current market value of the security 108A and/or other assets 108C linked to the investment card 102 and corresponding authorized funds available for expenditure on the investment card 102 to determine whether the account 108 has sufficient funds to pay for the transaction. A data repository 118 may be configured for receiving data related to the value of the securities 108A and/or other assets 108C from a securities exchange data feed 120 and/or currency exchange data from a currency exchange data feed 122. For example, the data repository 118 may be configured to communicate security 108A value data and/or currency exchange data to the card network 114, the transaction processor 116, and/or the financial institution 106, among other entities. If the investment card 102 is valid and there are sufficient funds available to pay for the purchase, then the transaction is completed. An alert or notification may then be sent to the cardholder 104, or an access device associated with the cardholder 104, via email, text message, smart phone application, or many other electronic media.

In various embodiments, the transaction processor 116 may process a transaction by receiving value data from a merchant 110 regarding a transaction involving an investment card 102; receiving value data associated with the investment card 102 from the financial institution 106 through a card network 114; and processing the transaction in connection with the received transaction value data and the investment card 102 value data. In the context of foreign currencies, the transaction processor 116 may receive currency exchange data from the data repository 118. The transaction may then be processed in accordance with the investment card 102 value data, the security 108A data (and/or data associated with other assets 108C), and/or the currency exchange data. In certain embodiments, the data repository 118 may send or receive investment card 102 data to or from the financial institution 106. The data may include currency data and/or security 108A data associated with at least one security 108A linked to the investment card 102. In certain embodiments, data which are related to at least one currency exchange rate may be sent or received by the repository 118 to or from a card network 114. Value changes for securities 108A and/or other assets 108C linked to the investment card 102 resulting from conversion of the securities 108A from one currency to another currency can be calculated in connection with the various currency exchange rates. In certain embodiments, the merchant 110 and/or the merchant bank 112 may be linked for communication with the card network 114 to process various transactions described herein.

FIG. 3B illustrates an example of a process flow provided in accordance with various embodiments of the invention. At step 352, the cardholder 104 uses the investment card 102 to make a purchase from a merchant 110. At step 354, in connection with the involvement of the investment card 102 in the transaction, the merchant 110 communicates data associated with the card 102 to the merchant bank 112. The merchant bank 112 sends the card 102 data to the card network 114 at step 356. At step 358, the card network 114 communicates the card 102 data to the financial institution 106 or issuer. The issuer 106 may perform fraud analysis at step 360, such as to determine whether the investment card 102 is legitimate, and has not been reported lost or stolen, for example. The issuer 106 may then apply one or more algorithms at step 362, including wallet algorithms to determine which wallets 102A on the investment card 102 to access for payment to the merchant 110, for example, and/or payment algorithms to determine whether there are sufficient funds to pay for the transaction. If the wallet and/or payment algorithms demonstrate that there are sufficient funds to pay for the transaction, then the issuer 106 may communicate an authorization code to the card network 114 at step 364. The authorization code represents agreement by the issuer 106 to fund the purchase on behalf of the cardholder 104. At step 366, a determination can be made of the securities 108A and/or wallets 102A associated with the investment card 102 to be accessed to finance the purchase pursuant to the wallet and/or payment algorithms

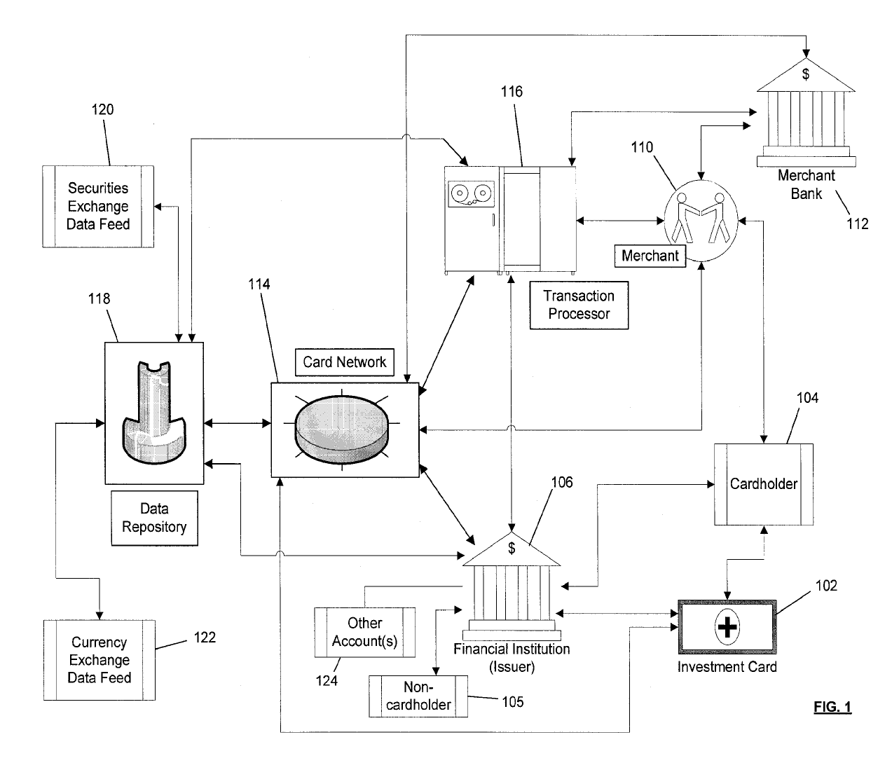

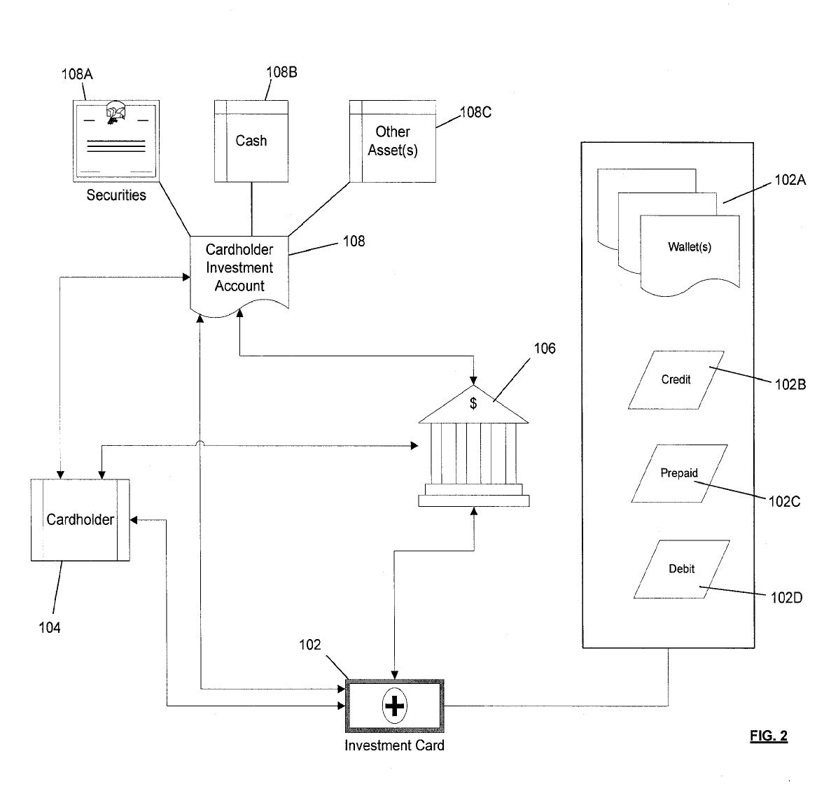

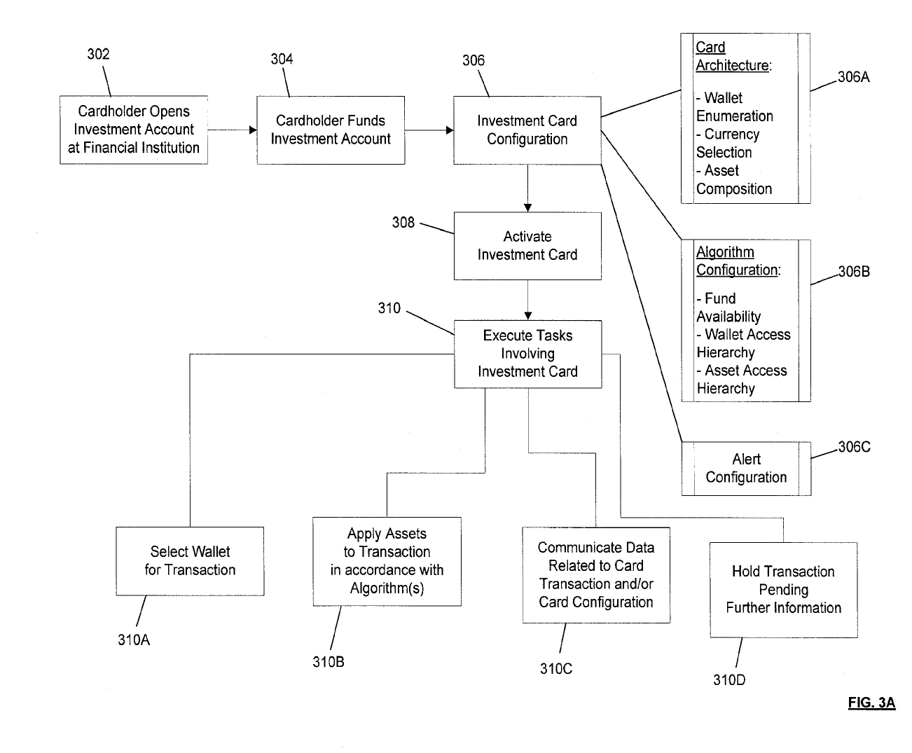

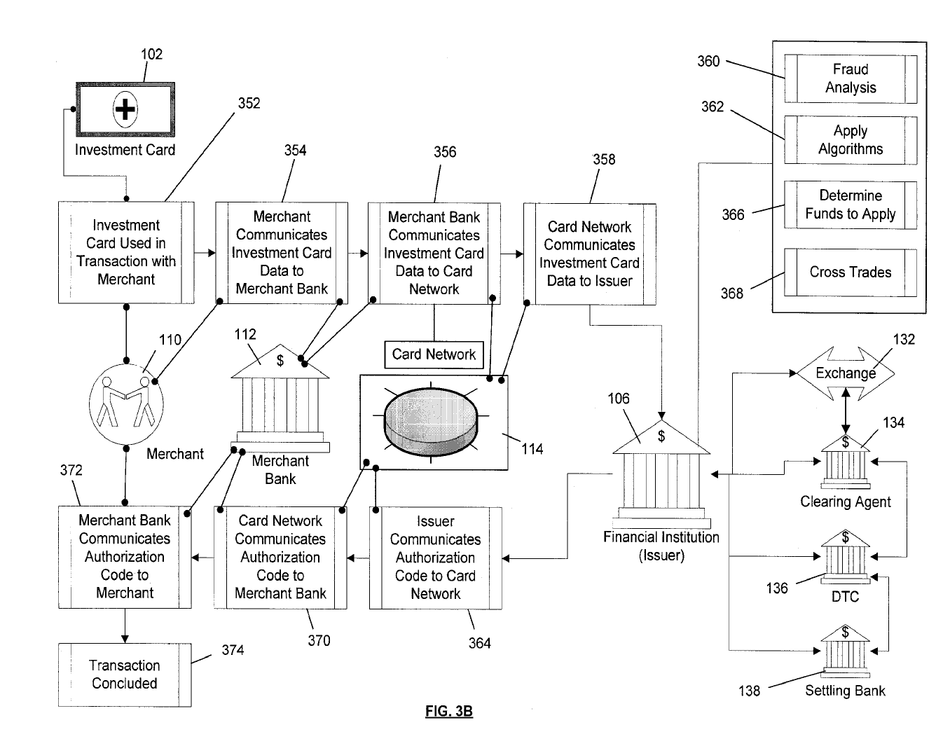

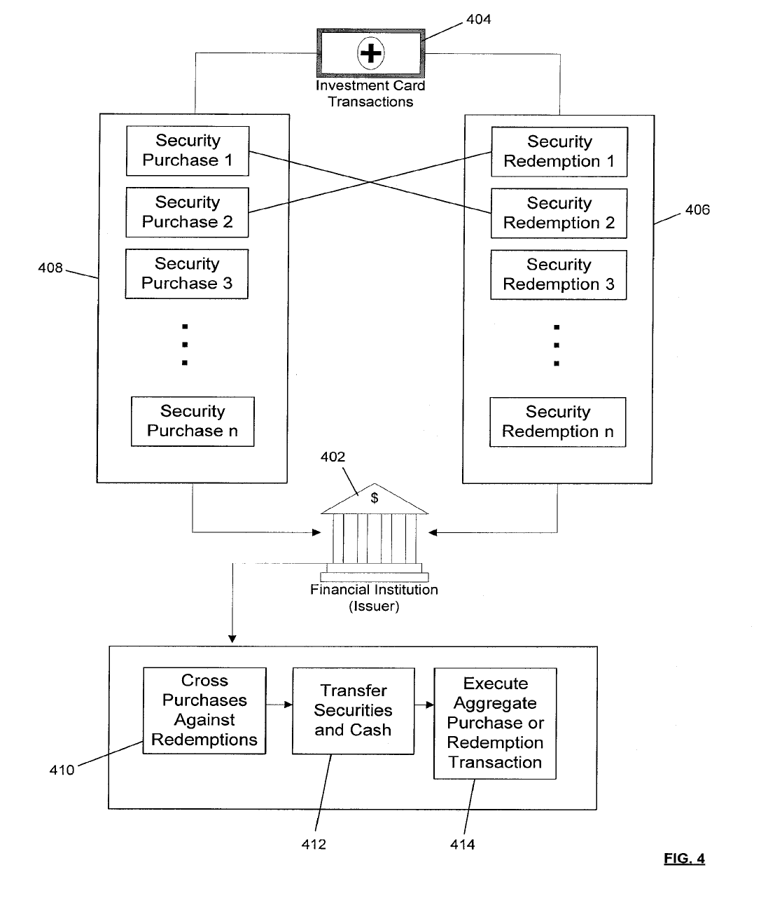

With reference to FIGS. 1 and 3B, at step 368, subject to applicable laws and/or regulations, the issuer 106 may cross the buy or sell order related to the investment cardholder account of the cardholder 104 with an order from a proprietary account, from another investment cardholder account 104, from a non-investment cardholder 105 client account, and/or from other accounts 124 associated with the issuer 106 (e.g., see discussion of FIG. 4 herein).

The issuer 106 may forward information related to the sale or purchase of securities 108A linked to the investment card 102 (e.g., the specific securities 108A to be sold, the quantity of such securities 108A, the currency in which such securities 108A are denominated, etc.) to the exchange or marketplace 132. In the case of a security 108A traded on a foreign exchange 132 (e.g., a security 108A traded on an exchange 132 in a different jurisdiction from that of the issuer 106), then the trade can be routed accordingly. Similarly, in the event that the securities 108A linked to the investment card 102 are ADRs or similar instruments, for example, then such instruments may be traded on a domestic exchange 132. After the trade is executed on the exchange 132, then the trade information can be communicated to a clearing agent 134 or comparable entity for post-trade processing. The clearing agent 134 can be, for example, a clearing house such as the NSCC (National Securities Clearing Corporation), a clearing firm such as Pershing, and/or a financial institution 106 that is self-clearing.

In various embodiments, the clearing agent 134 may perform a variety of services for the issuer 106 and cardholder 104, including creating computer-based account records on their behalf. The clearing agent 134 may process orders for the purchase, sale, or transfer of securities linked to the investment card 102 and/or may accept orders for securities 108A transactions for the investment card account 108 directly from the cardholder 104. The clearing agent 134 may receive and deliver cash 108B and securities 108A for the account 108 and/or may record such receipts and deliveries according to information provided either by the issuer 106 or the cardholder 104. Furthermore, the clearing agent 134 may hold in custody securities 108A and cash 108B received for the account 108 and/or may collect and disburse dividends and interest and process reorganization and voting instructions with respect to securities 108A held in custody. The clearing agent 134 may provide facilities for the preparation and transmission of confirmations of trades and/or may prepare and transmit periodic account statements summarizing transactions processed for the account 108.

In certain embodiments, if the issuer 106 opens a margin account for the cardholder 104, for example, then the clearing agent 134 may loan the cardholder 104 money for the purpose of purchasing or holding securities 108A subject to the terms of a written margin agreement, margin policies, and/or applicable margin regulations. The issuer 106 may retain responsibility for obtaining the initial margin amount as required by applicable laws and/or regulations (e.g., Regulation T). Thereafter, the clearing agent 134 or issuer 106 can calculate the amount of maintenance margin required. The clearing agent 134 or issuer 106 may also calculate the interest charged on the debit balance of the account, if any.

In connection with the various functions that the clearing agent 134 may perform, the clearing agent 134 may maintain the books and records required by law and by business practice. Furthermore, the clearing agent 134 may provide the issuer 106 with written reports of all transactions processed in connection with the investment card 102 to enable fulfillment of responsibilities under the clearing agreement. The clearing agent 134 may process and record trades, and/or provide the issuer 106 with a summary of compared or recorded trades, including information on net securities positions and net money to be settled.

The clearing agent 134 may send instructions to a depository trust company (“DTC”) 136 or comparable entity with net securities positions to be settled. As deliveries are processed, net money to be settled can be posted to a settlement system associated with the clearing agent 134. The DTC 136 transfers ownership of securities electronically, moving net securities positions from accounts of the issuer 106 to accounts of the clearing agent 134, and then from accounts of the clearing agent 134 to a buying broker's account, for example. A settling bank 138 sends or receives funds to/from the DTC 136 to complete settlement, at which time movements of securities become final.

At step 370, the card network 114 sends the authorization code to the merchant bank 112. The merchant bank 112 sends the authorization code to the merchant 110 at step 372, and then the merchant 110 can conclude the sale or other transaction involving the investment card 102 at step 374. The completed transaction can be entered into a ledger or other accounting or recordkeeping system, and settlement can occur by routing funds from the cardholder 104 account to the merchant 110 account.

With reference to FIG. 4, a card issuer 402 directly or indirectly holds the investment card accounts linked to investment cards. Investment cardholders can add funds to their investment card accounts, for example by sending cash to the card issuer 402, which in turn purchases the specified securities for their investment card accounts. Investment cardholders can also withdraw funds from their investment card accounts, for example, by using their investment cards to buy goods and services 404 from a merchant, in which case the card issuer 402 sells the specified securities in their investment card accounts to obtain the cash with which to pay the merchant. In various embodiments, the card issuer 402 may internally cross trades between or among activities that add funds to investment card accounts (e.g., security purchases 408) and activities that withdraw funds from investment card accounts (e.g., security redemptions 406). In one embodiment, the financial institution 402 receives redemption data related to selling a security associated with at least one redeeming investment card account. The financial institution also receives purchase data related to buying a security associated with at least one purchasing investment card account. At step 410, the financial institution 402 determines matches between the redeeming investment card account securities and the purchasing investment card account securities. In response to determining the existence of a matched investment card account security, the financial institution 402 may aggregate matched investment card account security transactions into a net redemption transaction or a net purchase transaction. At step 412, cash amounts may be transferred to redeeming investment card accounts in response to the redemption data, and certain quantities of the matched investment card account security may be transferred to purchasing investment card accounts in response to purchase data.

As noted above, subject to applicable laws and/or regulations, the issuer 402 may cross the buy or sell order related to the investment cardholder account with an order from a proprietary account, from another investment cardholder account, from a non-investment cardholder client account, and/or from other accounts associated with the issuer 402. In certain embodiments, a security purchasing investment card account may be replaced by another type of security purchasing account; a security redeeming investment card account may be replaced by another type of security redeeming account; and/or other combinations involving different accounts may be possible.

At step 414, a net redemption transaction or a net purchase transaction, as appropriate, may be executed which reflects aggregation of the various crossed security purchase and redemption transactions. Those skilled in the art will appreciate that it may be necessary under certain circumstances to apply a residual cash algorithm when at least one transaction would otherwise involve a fractional amount of a security. In other words, transactions frequently involve processing whole numbers of shares (i.e., execution of redemptions or purchases of partial shares may not be possible or permitted), and a certain amount of cash may be needed to reconcile the transaction. In certain embodiments, a net redemption transaction may be executed at a time when a price associated with the matched security is lower than an average price of the matched security during a given time period, or at a minimum point for a predetermined time period (e.g., different times within the same trading day). Likewise, a net purchase transaction may be executed at a time when a price associated with the matched security is higher than an average price of the matched security during a given time period, or at a maximum point for a predetermined time period. In this manner, as applicable laws and regulations may allow, the issuer 402 can maximize profits derived from both buying and selling securities.

In one example of crossing trades, assume that both Cardholder Z and Cardholder X link their respective investment cards to the same security and both initially load their cards with USD 500. Assume Cardholder Z spends USD 75 on a given purchase, and that same day Cardholder X adds an additional USD 100 to his card. Rather than placing a sell order of USD 75 in underlying securities on behalf of Cardholder Z and a buy order of USD 100 in underlying securities on behalf of Cardholder X, the card issuer may internally cross that transaction. More specifically, the card issuer can move the equivalent of USD 75 of the underlying security from the account of Cardholder Z to the account of Cardholder X and also execute a buy order of USD 25 on behalf of Cardholder X; similarly, USD 75 of the USD 100 that Cardholder X sends to the card issuer will be set aside to pay for Cardholder Z's purchase, with such amount being sent via the card network and processor to the merchant's account. This process can also work in the other direction, so that if the aggregate purchases exceed the aggregate deposits in a given time interval, those amounts can be crossed and the card issuer 402 can then place a single sell order for the net difference. It can be seen that this internal crossing activity provides significant efficiencies for the different parties involved. The card issuer 402 is able to reduce the size and volume of trades, thereby reducing intrinsic costs and risks, while the investment cardholders are able to obtain faster settlement of their trades.

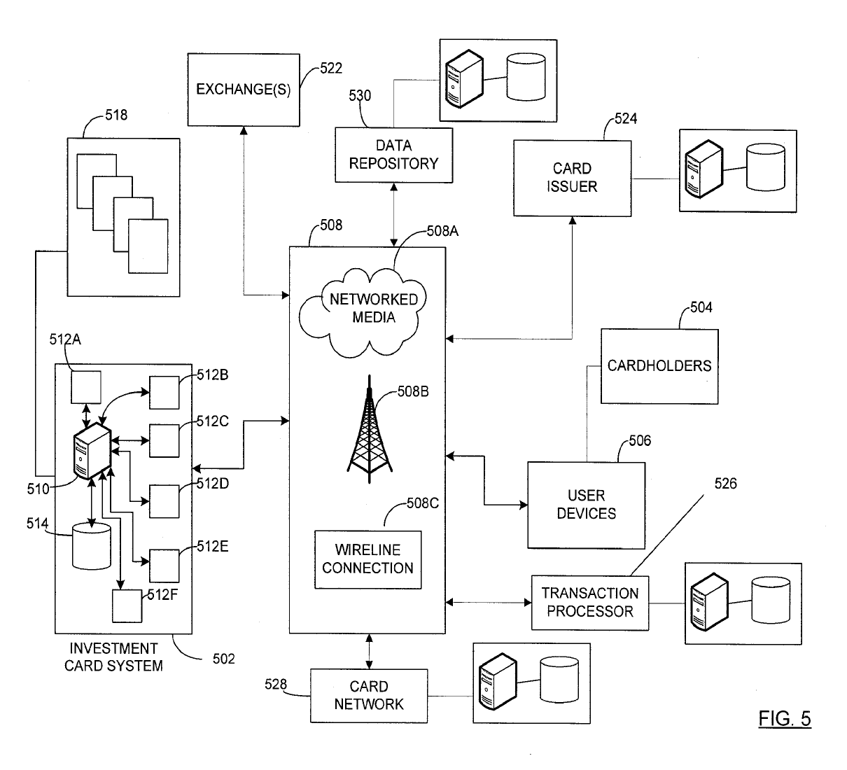

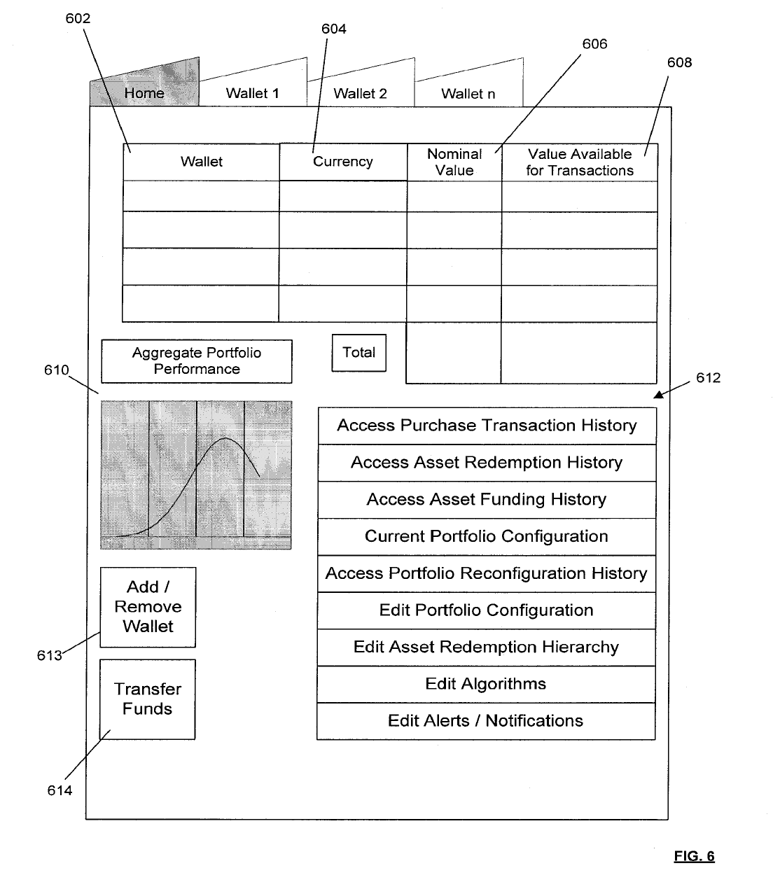

FIG. 5 schematically illustrates an example of a computer system architecture structured in accordance with various embodiments of the invention. FIG. 5 illustrates an example of an investment card system 502 installed in operative association with a financial institution and programmed to receive, process, and communicate data related to one or more investment cards configured for various cardholders 504. Cardholders and other entities can access the data stored by the investment card system 502 through a variety of user devices 506. The user devices 506 may be embodied as any computer system or computer device capable of communicating with the investment card system 502 through one or more communication media 508. Examples of user devices 506 include, without limitation, smart phones (e.g., “iPhone” or “Blackberry” devices), tablets (e.g., “iPad”), mobile phones, notebooks, laptops, personal computers, and many other types of devices. Examples of the communication media 508 include, without limitation, networked media 508A (e.g., Internet, intranet, cloud computing, etc.); wireless connection 508B; and, wireline connection 508C. In certain embodiments, the user interfaces, alerts, notifications, and other data processing described herein can be facilitated or communicated through one or more types of mobile applications that can be displayed or accessed through one or more mobile types of user devices 506, for example.

In the example shown in FIG. 5, the investment card system 502 includes a computing apparatus 510 and one or more modules 512A-512F that perform various functions in connection with the computing apparatus 510. The computing apparatus 510 may be a web server, for example, or another type of computer system that can be programmed to manage and execute the functions performed by the system 502. The module 512A-512F may be programmed to manage and execute various functions or tasks of the system 502 including, for example, configuring parameters of an investment card, processing data associated with purchases made using investment cards, processing data related to underlying securities or other investments, executing various algorithms associated with investment cards (as described above), processing and displaying account pages for cardholder access, among many other tasks. All or part of the investment card system 502 may be incorporated into a cloud computing platform, for example. The system 502 may include one or more suitable data storage media 514 programmed for storing and providing access to data and other information which are processed by the system 502. The data storage media 514 may include a variety of different kinds of databases or other computer memory devices capable of storing data related to transactions, investment accounts, or investment cards.

In various embodiments, the investment card system 502 may access one or more investment card accounts 518 associated with one or more investment cards. At least part of the information contained in the investment card accounts 518 may be supplied through communication of security value data and/or currency exchange data from one or more exchanges 522, or other media in which securities and other investments are bought, sold, traded, etc. In certain embodiments, a card issuer 524, a transaction processor 526, a card network 528, and/or a data repository 530 may communicate among each other and/or with other entities through the communication media 508 as part of various transactions involved with configuring and using investment cards.

In accordance with FIG. 5, it can be seen that the investment card can be tied to a data platform (e.g., the cloud) that provides an overview of the securities associated with the card, wherein the data are accessible via smart phone, computer, phone, and/or similar devices 506. The data platform can be configured to enable the cardholder 504 to perform various tasks, such as: get a graphical overview of an investment card, including accounts, balances, allocations, and performance; track the performance of associated securities historically and in real time; track the performance of associated securities along certain metrics, including gain/loss, volatility, and performance against other securities/indexes; receive notifications for associated securities including the release of earnings report, analyst recommendations and estimates, open/close price, bid/ask price, beta, PE, EPS, range over X interval of time, and financial statements; and/or, access statements of his current and past card activity, including card loads, card expenditures, and fees. The data platform can enable card issuers 524 and cardholders 504 to communicate various types of information, including: actual portfolio configuration; nominal value of portfolio in listed and alternative currencies; funds available for expenditure in listed and alternative currencies; algorithm specifying how funds available are derived from nominal value; issuing bank informing cardholder of automatic portfolio reconfiguration; and/or, cardholder 504 informing bank of selected portfolio reconfiguration, among others.

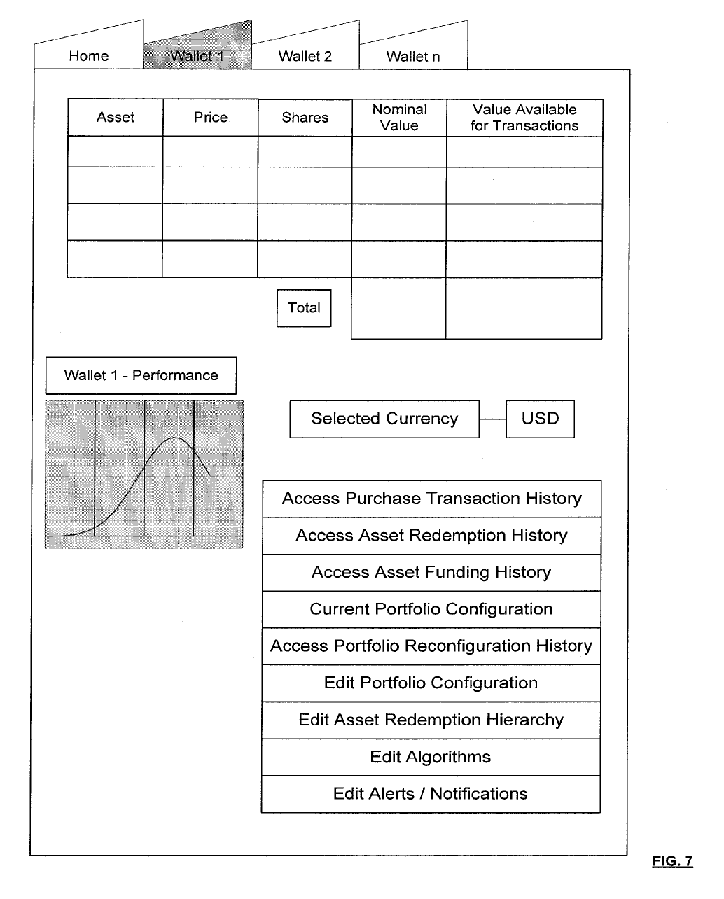

With reference to the screen displays illustrated in FIGS. 6 through 9, the cardholder can be provided with access to information regarding the value in the investment card account and funds available for expenditures. Tools can be provided to allow cardholders to add funds and/or to move or transfer funds among various securities and/or wallets via a computer, smart phone, or other device used to send and receive data. The cardholder can access the home page of his investment card, for example. The cardholder can either go to a default page or a customized page that contains account information. One or more account pages may provide various kinds of information. In various embodiments, algorithms can be configured or activated by one or both of the cardholder 104 and/or the financial institution 106.

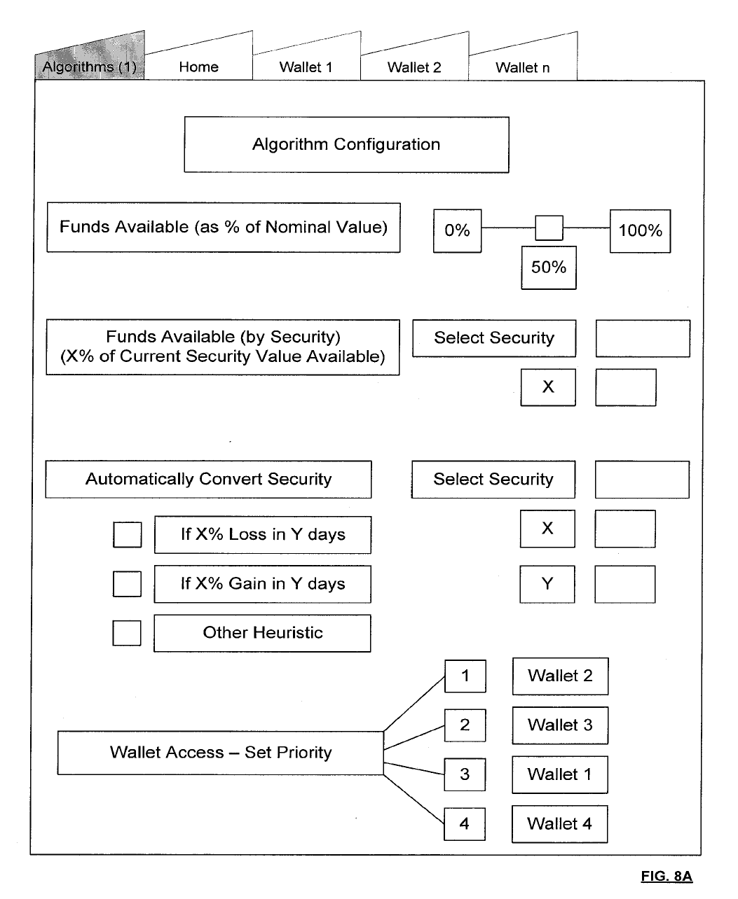

In the examples shown in FIGS. 6 and 7, pages may be provided to display what wallets 602 are available on the card; the currency 604 in which each wallet is denominated; nominal value 606 of each wallet; and/or, funds available 608 for expenditure or transactions for each wallet. An aggregate portfolio performance 610 can be displayed across all wallets. Also, various links 612 to different functions can be provided such as purchase transaction history, asset redemption history, asset funding history, current portfolio configuration, portfolio reconfiguration history, edit portfolio configuration, edit asset redemption hierarchy, edit algorithms, edit alerts/notifications, among others. A function 613 can be provided to allow the investment cardholder to add or remove wallets to or from the card 102. Another function 614 can be provided if the investment cardholder wants to move or transfer funds among various wallets. Performance may be displayed as the high, low, and average price of each security linked to a wallet; the increase/decrease in absolute and percentage terms between when the security was purchased and current date; and/or as the relative performance of all such securities on a given wallet and across wallets, among other variations.

In the context of multiple wallets, the security or securities 108A or other assets 108C to which each wallet is linked can be displayed. The “home” screen of FIG. 6 may include a series of tabs, wherein each tab provides information for a separate wallet on a single card 102 and a master tab or home page that presents the aggregate information for all wallets so that in a single display information can be presented regarding the total nominal value and funds available in a single or multiple currencies. For example, the screen display of FIG. 7 includes data pertinent to Wallet 1 of the investment card 102. It can be seen that one or more of the individual wallets may be linked to different currencies, including those for the same security traded on multiple exchanges (e.g., SAP, which is listed on the NYSE in USD and the FWB (Frankfurt exchange) in EUR). For example, the investment cardholder 104 can have two wallets, each linked only to SAP shares, but with one wallet USD denominated and used for United States purchases and another wallet EUR denominated and used for Eurozone purchases.

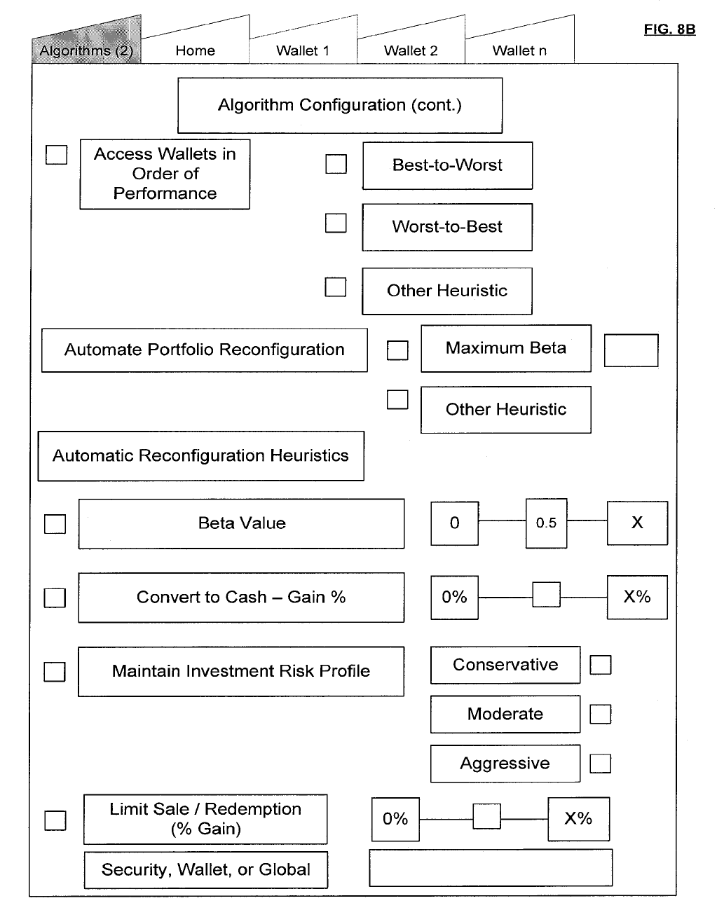

FIGS. 8A and 8B include examples of screen displays that permit access to information regarding whether and how a portfolio should be automatically or manually reconfigured or adjusted in accordance with certain algorithms. Automatic portfolio reconfiguration may include data related to the portfolio prior to and subsequent to reconfiguration; the algorithms used to reconfigure the portfolio; whether the portfolio should be reconfigured by creating or modifying algorithms that automatically reconfigure the portfolio according to a specified trigger (e.g., an algorithm may automatically reconfigure a portfolio so that it does not exceed a beta of 1.5, i.e., a beta of 1.5 is an automatic trigger for portfolio reconfiguration). Portfolio reconfiguration can be either qualitative or quantitative. An example of qualitative reconfiguration may include a slide bar wherein a portfolio can be associated with a low or high beta. As the slide bar is moved, appropriate portfolio recommendations corresponding to a predetermined beta level can be displayed. An example of quantitative reconfiguration may include a tool that enables, for example, placement of a sell order on any security 108A that drops in value more than X percent in a defined time period and/or falls by more than Y dollars in a defined time period.

A hierarchy of rules, which may be expressed and executed as wallet algorithms, for example, can be provided for wallets that are denominated in various currencies. For example, wallets first accessed may be those denominated in the currency which is the same as the transaction currency. If there are multiple wallets that are denominated in the transaction currency, then intra-currency hierarchy rules may be applied. If no wallets are denominated in the transaction currency, then either a default rule (e.g., wallet with the greatest sum of available funds, or wallet denominated in the currency with the greatest appreciation in value against the transaction currency over the prior X interval of time) or another predetermined rule may be applied.

In another example shown in FIG. 8B, one or more limits can be placed on amounts available to spend with the card 102 for a given transaction in response to portfolio performance, including the securities 108A or other assets 108C associated with the portfolio. For example, if GM stock is a security 108A associated with the card 102 and the GM stock performs well (e.g., quantified as more than 5% in a week, 10% in a month, and/or another performance metric over a predetermined time period), then a limit can be placed on using the GM stock for transactions. It can be appreciated that the opportunity cost associated with liquidating the GM stock may be deemed to be too high to permit use of the GM stock for a purchase transaction, for example. The limit may be configured as an algorithm that operates on a security-by-security basis or wallet-by-wallet basis, or may globally affect all transactions involving the card 102. For example, if the overall portfolio performance associated with the card 102 appreciates (or depreciates) by a specified performance metric level over a predetermined time period, then transactions involving the card 102 may be limited or completely frozen.

Also, screen displays can be provided that show the algorithms underlying the card 102, which may include any or all of: the algorithms related to funds available as a portion of the nominal account value, so that amounts available for expenditure can be displayed as derived from the value of portfolio holdings. Algorithms related to portfolio reconfiguration can be displayed to show how the portfolio was reconfigured and what event or events triggered such reconfiguration. For example, if the portfolio was reconfigured in response to a security 108A in the portfolio losing more than X percent in value in Y period of time, then a screen may display the security 108A sold, the amount received upon such sale, and how these sale proceeds were allocated—which explains both the current portfolio configuration and why the reconfiguration occurred. The cardholder 104 may be allowed to modify the values for X and Y, for example. Algorithms related to the hierarchy in which wallets are accessed can be displayed, so that the cardholder 104 or others can see which wallets were used to pay for a given expenditure, as well as whether multiple wallets were tapped for a given expenditure. For example, the cardholder 104 may modify the hierarchy in which wallets are accessed (e.g., specifying that if one wallet is insufficient, the wallet with the highest amount of available funds should be first accessed, or the wallet with the poorest performance over Y period of time should be first accessed, etc.).

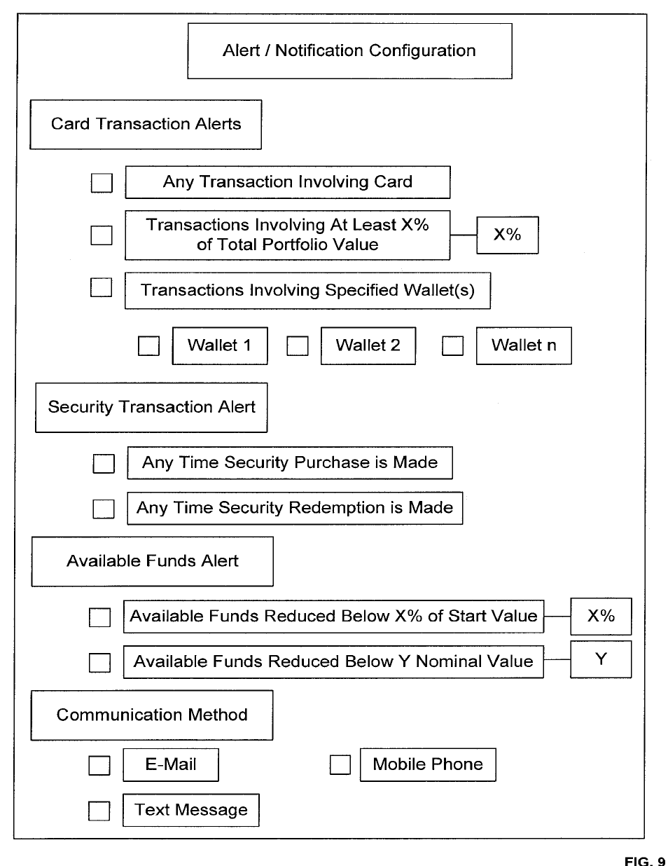

FIG. 9 illustrates an example of a screen display that permits configuration of various alerts or notifications for the investment card 102. Alerts may be sent pursuant to automatic or manually defined rules. For example, alerts may include information regarding when nominal funds available and/or funds available for expenditure have decreased below a given level; when a given security 108A (or portfolio of securities 108A) has increased or decreased in price by certain absolute or percentage terms; and/or, when a specified portfolio reconfiguration trigger has been activated, among many others. In various embodiments, alerts, notifications, and/or their associated screen displays can be presented with the look and feel of the card issuer 106 and/or the card network 114, including linking to displays and/or applications provided by such entities. For example, a brokerage seeking to present investment information more efficiently, particularly for smart phone trading, may want to allow investment cardholders 104 to access the same displays and applications available to their non-cardholder clients.

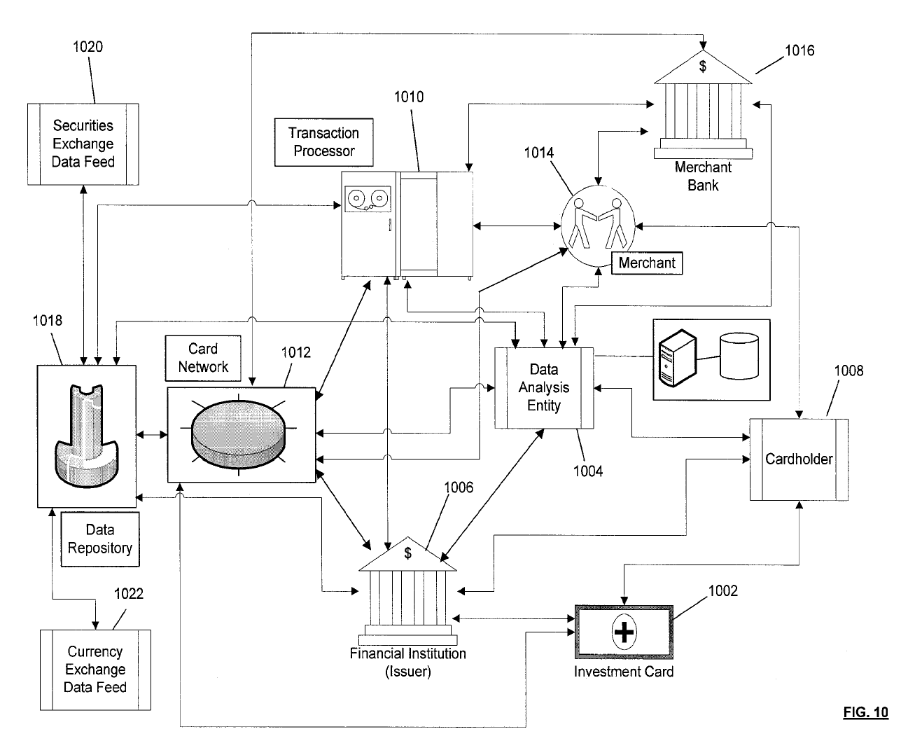

In various embodiments, and with reference to FIG. 10, data collected during transactions and other processes involving an investment card 1002 may be collected by a data analysis entity 1004 and used for a variety of different purposes. As described above in connection with various embodiments of the invention, data may be collected or communicated with a financial institution 1006, a cardholder 1008, a transaction processor 1010, a card network 1012, a merchant 1014, a merchant bank 1016, a data repository 1018, a securities exchange data feed 1020, and/or a currency exchange data feed 1022, among other potential entities associated with transactions involving the investment card 1002. For example, the data analysis entity 1004 may process spending history data and/or portfolio preferences associated with the investment card 1002. Such data can be used to target advertising regarding products or services (e.g., travel offers for cardholders 1008 who travel frequently), as well as to recommend certain securities (e.g., for cardholders 1008 with an appetite for highly rated corporate bonds, information regarding comparable tax-free municipal bonds can be communicated). The data analysis entity 1004 may also process and analyze cardholder 1008 spending patterns, merchant 1014 selling patterns, and/or cardholder 1008 investment/divestment patterns. In various embodiments, data can be analyzed to enhance efficiencies and offerings for various entities, including providing targeted advertising of products or services, investment recommendations, and special offers on products or services from merchants 1014 to cardholders 1008.

In another example, the data analysis entity 1004 and/or the financial institution 1006 may link transactions involving the purchase and/or sale of securities to a rewards program. For example, for a predetermined amount or value of securities purchased and/or sold in connection with investment card 1002 transactions, a predetermined number of points may be awarded that can be used for rewards such as airline miles, gift certificates for products or services, cash back programs, or other bonuses.

Those skilled in the art can appreciate that the act in which the cardholder authorizes a purchase or other transaction is frequently the same act in which a sale of securities is authorized in an amount corresponding to the transaction amount. If the card is used in a fraudulent manner, however, then the account may need to be credited with cash associated with the fraudulent transaction, as well as an amount of securities that had been sold to fund the fraudulent transaction. In various embodiments, the financial institution and cardholder may agree that amounts involved in a fraud situation can be credited in cash and/or securities as desired by agreement between the parties. In various embodiments, one or more anti-fraud protections, algorithms, and/or alerts that have been used for traditional credit cards, debit cards, and prepaid cards can be modified or extended to provide similar preventative protection for the investment card.

It is the intent of the inventor that the various embodiments of the invention described herein should be practiced in appropriate legal and regulatory operating environments. Various embodiments of the invention are intended to be structured for compliance with all applicable local, state, and federal laws and regulations. For example, in accordance with issuer policies and regulatory requirements, applicable fees, commissions, costs, and/or taxes related to the sale of securities resulting from use of the investment card may be deducted from the account in connection with purchases involving the card.

### OPERATIONAL EXAMPLES

The following examples are non-exhaustive illustrations of executing different algorithms, alerts, notifications, and conducting other tasks or activities in accordance with various embodiments of the invention. By development and application of the algorithms, for example, relevant entities can be empowered to implement paradigms to determine the relationship between the nominal value of the investment cardholder's account and the funds available for authorized spend, and to quantify each based upon the respective risk profiles of the relevant parties.

In one example of an algorithm related to fund availability, assume that on the start of a given day (such as 7 Sep. 2012) the share price of GM was USD 22.67 and Cardholder Z had 100 shares of GM in the securities account linked to his investment card. A problem arises regarding whether Cardholder Z's purchase of USD 2,000 should be authorized, as depending upon when the purchase is made and when authorization is sought there may or may not be sufficient funds in the account to pay for such purchase due to the fact that the GM share price is frequently changing.

To address this problem, one or more of the relevant parties may establish an algorithm to determine whether such purchase should be authorized. For example, the card issuer may establish a very conservative algorithm which looks at the historic volatility of the underlying security, in this case that of GM. As of 7 Sep. 2012, the 52 week low and high for GM stock were USD 18.72 and USD 27.68. Thus, the card issuer may employ the following algorithm to determine Cardholder Z's funds available for expenditure, i.e., the maximum sum that will be authorized: A≤(O×N)×(1−P), where A=the maximum amount of authorized spend; O=the opening price of the underlying security (USD 22.67); and, N=the number of shares of the underlying security in the cardholder's account (100). Also, P=D/M, which in this case is (USD 4.48/USD 23.20)=19.31%, where M=the mean of the 52 week low/high ((the high and low stock price over the preceding 52 weeks) divided by 2), which in this case is ((USD 18.72+USD 27.68)/2)=USD 23.20; and, D=the differential between M and the 52 week low stock price, which in this case is (USD 23.20−USD 18.72)=USD 4.48. Thus, in this example, the card issuer would apply the algorithm: A (USD 22.67×100)×(1−(USD 4.48/USD 23.20)), ≤(USD 2267)×(0.8069), ≤USD 1829.24. Accordingly, by application of a comparatively more conservative algorithm, the purchase authorization request for USD 2,000 would be denied.

Assume the same facts but a card issuer with a less conservative algorithm, and rather than referencing the mean of the 52 week low/high it references the mean of the previous four days on a rolling basis, which in this case corresponds to low and high share prices of USD 21.14 and USD 22.45. Thus, the card issuer would calculate: A (USD 22.67×100)×(1−(USD 0.66/USD 21.80)=3.03%), ≤USD 2267×0.9697, ≤USD 2198.31. In this example, by application of the less conservative algorithm, the purchase authorization request for USD 2,000 would be approved. Thus, even assuming the same nominal value of the portfolio on 7 Sep. 2012 of USD 2267, application of different values for P in this algorithm yield different authorization decisions for Cardholder Z and Cardholder X.

To further illustrate the possible interrelationship between the cardholder choice of security and the card issuer choice of algorithm, assume Cardholder X links his investment card to the stock of General Mills and—like Cardholder Z—the nominal (i.e., market) value of his account on 7 September 2012 is USD 2267. The 52 week low/high for General Mills stock as of 7 Sep. 2012 was USD 36.61/USD 41.06, yielding a value of P of 6.07%. Therefore, application of the more conservative algorithm yields the following result: A≤USD 2267×0.9392, ≤USD 2129.17. Consequently, in this example, for securities that have a smaller differential D (i.e., are less volatile), the percentage of the nominal value of the account available for expenditure will be higher, while for securities that have a larger differential the percentage will be lower, an algorithm that substantially reduces the risk that the funds linked to the cardholder's account will be insufficient to pay for a given expenditure. So, because Cardholder X linked the investment card to a security whose historic volatility is less than one-third that of Cardholder Z, even application of the more conservative algorithm results in authorization of the purchase for USD 2,000.

In various embodiments, the investment card may be linked to a security denominated in a currency different from the residence of the cardholder and/or the card issuer. For example, a U.S. resident may obtain an investment card linked to British Telecom, which is a U.K. security denominated in British Pounds (GBP), from a card issuer in the U.S., the U.K., or any other jurisdiction. In this example, although British Telecom shares are listed and traded in GBP, the investment card obtained by the U.S. resident and linked to British Telecom may be denominated in USD or GBP as the relevant parties so choose. Furthermore, transactions can be processed in cases where the currency denomination of the investment card is different from the currency in which the transaction occurs. For example, an investment card linked to General Motors (a security denominated in USD) can be used to pay for a purchase in the UK, regardless of whether the purchase is denominated in GBP, USD, or any other currency.

Algorithms can be based on many different types of performance metrics, not only volatility. For example, if applied in the context of the financial institution determining funds available for spend, an algorithm could be based on a fixed percentage which continually readjusts, e.g., 20% of funds are reserved, so that if one starts with a nominal account value of USD 1,000, then USD 200 is reserved (i.e., USD 800 is available for authorized spend). When a purchase of USD 500 is made—leaving a nominal balance of USD 500—then the reserved funds are recalculated to USD 100 (20% of the nominal balance of USD 500) so that funds available for spend are USD 400 (USD 500 of revised nominal account value—USD 100 of revised reserved funds). When another purchase of USD 200 is made—leaving a revised nominal balance of USD 300, then the reserved funds are recalculated to USD 60 (20% of the revised nominal balance of USD 300) and funds available for spend are USD 240 (USD 300 of revised nominal account value−USD 60 of revised reserved funds). This algorithm could be re-applied until the remaining funds approach zero.

As described above, in certain embodiments, a single investment card can be comprised of multiple wallets, whereby each individual wallet is linked to a separate security or cash. Furthermore, in the context of a multi-wallet investment card, a wallet algorithm can be configured to determine the order in which the various wallets are accessed. For example, assume the investment cardholder would like to have one investment card account linked to shares of General Motors, a second investment card account linked to shares of General Mills, and a third investment card linked to shares of Apple. The investment cardholder can have three separate cards—each tied to a separate security—or combine all three securities on a single multi-wallet investment card.

In the context of a multi-wallet investment card, the relevant party could establish a wallet algorithm to determine which wallet is accessed for a given expenditure. For example, if General Motors stock has been outperformed by that of General Mills and Apple over a defined time interval—e.g., over the previous week or month—then the algorithm could operate to default to the wallet of the worst performing security. In this case, the General Motors wallet would be used to pay for a given expenditure. A modification of this algorithm, as applied to this example, would stipulate that each wallet would be depleted before accessing another wallet, beginning with the worst performing security and progressing to the best performing security. Thus, if General Motors stock was underperforming General Mills stock, and General Mills stock in turn was underperforming Apple stock, then the wallet containing the General Motors stock would be depleted first. If the funds in the General Motors wallet were insufficient to pay for a given expenditure, then after the General Motors wallet was depleted the General Mills wallet would be accessed. If the funds in the General Motors wallet and the General Mills wallet together were insufficient to pay for a given expenditure, then the Apple wallet would be accessed as necessary to provide sufficient funds for the purchase. This process could extend for each wallet contained on a single card.

In another example, the algorithm could operate to default to the wallet with the smallest amount of funds. In this case, if at the time of expenditure the respective share prices were USD 22.98 for General Motors, USD 39.29 for General Mills, and USD 662.74 for Apple (as were the closing prices on 10 Sep. 2012), and the multi-wallet investment cardholder had one share of each linked to his card, then the wallets could be accessed in that order to pay for a given expenditure.

In another example, the algorithm could operate to default to the wallet tied to the highest beta of a given stock. In this case, if at the time of expenditure the respective betas were 1.35 for General Motors, 1.22 for Apple, and 0.15 for General Mills (as were the closing betas on 10 Sep. 2012), then the wallets could be accessed in that order to pay for a given expenditure, so that the volatility of the investment cardholder's portfolio would be progressively reduced via investment card expenditures.

In various embodiments, the multi-wallet investment card may be linked to a portfolio of securities denominated in a currency (or currencies) different from that where the investment cardholder and/or card issuer are resident. For example, a U.S. resident may obtain a multi-wallet investment card linked to General Motors, British Telecom, and Repsol, which is a Spanish security denominated in Euros (EUR) from a card issuer in the U.S., the U.K., Spain, or any other jurisdiction. In this example, the investment card obtained by the U.S. resident and linked to General Motors, British Telecom, and Repsol may be denominated in USD, GBP, and/or EUR, or any other currency as the relevant parties so choose. More specifically, the relevant parties may link each of these separate securities to the respective currencies in which they are denominated, so that the sole multi-wallet investment card would have a General Motors wallet denominated in USD, a British Telecom wallet denominated in GBP, and a Repsol wallet denominated in EUR. Alternatively, the relevant parties may link each of these respective securities to a single currency, which in this example could be USD, GBP, EUR, or an alternative currency not tied to any of the linked securities.

In certain embodiments of the investment card, transactions can be processed in cases where the currency denomination of the multi-wallet investment card is different from the currency in which the transaction occurs. For example, the multi-wallet investment card referenced above can be used to pay for a purchase in any country, regardless of whether the purchase is denominated in a currency that comprises in whole or part the multi-wallet investment card. More specifically, the multi-wallet investment card referenced above can be used to pay for a purchase denominated in USD, GBP, EUR, or any other currency. Therefore, regardless of whether the above referenced multi-wallet investment card is denominated in USD, GBP, or EUR, it could for example be used in Thailand to pay for a purchase denominated in Thai Baht (THB).

In each of these examples, the algorithm could operate to determine when cash will be accessed. In one example, the algorithm could stipulate that cash will always be the first wallet accessed. In another example, the algorithm could stipulate that cash will always be the last wallet accessed. In another example, the algorithm could stipulate that cash will be accessed to complete the price of a given expenditure when the value of a given security (V) does not evenly divide into the price (P), so that if the security being accessed is valued at USD 12.34 (V=USD 12.34) and the price of the item is USD 25.00 (P=USD 25.00), then P/V=2.03; therefore, two shares will be sold (2*USD 12.34=USD 24.68), and the remaining amount (USD 25.00—USD 24.68=USD 0.32) will be completed in cash.

In an example of a conversion algorithm related to conversion of funds, an investment card may be linked to at least one security account and a linked cash account, so that the investment card is linked to a pool of funds comprised of a security and cash. Such an arrangement may provide for both automatic and voluntary conversion of securities into cash, or securities into other securities. Furthermore, a conversion algorithm could determine a hierarchy by which the security account(s) are converted into other securities and/or cash.

In an example of a conversion algorithm to automatically convert a security into other securities and/or cash, when the balance available on an investment card is less than the value of the underlying security, the balance may be automatically converted into cash to allow the card to access all of its funds. For example, assume Cardholder Z referenced above has an account with a nominal value of USD 2,267 and authorized available funds of USD 2,198, and further assume he makes an expenditure of USD 2,190. Because the expenditure amount is less than the authorized available funds, then the purchase is approved. Note, however, that the remaining balance of authorized available funds (USD 2,198−USD 2,190=USD 8) is less than the price of a single share of GM stock (USD 22.67 was the opening price for GM stock on 7 Sep. 2012, for example). Therefore, a conversion algorithm could be applied by which there is an automatic conversion of funds from GM stock to cash.

When the balance available on a multi-wallet investment card is less than the value of the primary underlying security, the balance may be converted into other securities and/or cash to allow the investment cardholder to access all of his funds. For example, assume the facts above—but that Cardholder Z has a multi-wallet investment card linked to General Motors stock, Sprint Nextel stock, and cash. If on the day of Cardholder Z's expenditure the price of Sprint Nextel stock were USD 3 per share, then the relevant parties could develop a conversion algorithm by which there is an automatic conversion of the remaining funds into the security with the lowest per unit price—in this case, Sprint Nextel stock—so that 2 ((USD 8, the remaining balance of authorized available funds)/(USD 3, the price of Sprint Nextel stock)=2.67 shares, which defaults to the lowest whole number, i.e., 2 shares) additional shares of Sprint Nextel stock would be added to Cardholder Z's multi-wallet investment card. The algorithm could further provide the final balance (USD 2, which is the initial balance of USD 8 minus the USD 6 converted to Sprint Nextel stock) would be automatically converted to cash.

In another example, assume the facts above—but that Cardholder Z has a multi-wallet investment card linked to General Motors stock, Sprint Nextel stock, Jones Soda stock, and cash. If on the day of Cardholder Z's expenditure the price of Sprint Nextel stock were USD 3 per share and the price of Jones Soda stock were USD 0.36, then the relevant parties could develop an algorithm by which there is an automatic conversion of the remaining funds into the security with the higher price or better performance, which in this example is Sprint Nextel. Thus, there would be an automatic conversion of the remaining funds into Sprint Nextel stock, so that 2 ((USD 8, the remaining balance of authorized available funds)/(USD 3, the price of Sprint Nextel stock)=2.67 shares, which defaults to the lowest whole number, i.e., 2 shares) additional shares of Sprint Nextel stock would be added to Cardholder Z's multi-wallet investment card. Next, there would be an automatic conversion of the residual funds of USD 2 (USD 8−USD 6=USD 2) into Jones Soda stock, so that 5 ((USD 2, the residual balance of authorized available funds)/(USD 0.36, the price of Jones Soda stock)=5.55 shares, which defaults to the lowest whole number, i.e., 5 shares) additional shares of Jones Soda stock are added to Cardholder Z's multi-wallet investment card. The algorithm could further provide the final balance (USD 0.20, which is the balance of USD 2.00 minus the USD 1.80 converted to Jones Soda stock) would be automatically converted to cash.

In addition to or in lieu of the automatic conversion referenced above, an algorithm can be applied to allow optional conversion from the primary underlying security into other securities and/or cash. An example of optional conversion to other securities and/or cash could be achieved by a variety of algorithms, including those linked to the performance of the underlying security, the beta of the underlying security, and/or other metrics:

In the context of an investment card linked to a single security, if the security loses more than X percent of value in a given day or Y percent of value in a given month, then the security may be at the investment cardholder's option converted to cash.

In the context of a multi-wallet investment card, if a security loses (or multiple securities lose) more than X percent of value in a given day or Y percent of value in a given month, then the security may be converted into the security in the wallet with the greatest increase in value in the defined time period, for example, over the preceding day or month, or alternatively converted into cash.

In the context of a multi-wallet investment card, a range of values can be specified for beta. In the event that the portfolio configuration linked to such card moves outside of the value range, then the portfolio can be reconfigured via purchase and sale of the underlying securities to bring beta back into the specified range. A modification of this algorithm could further provide that in the event the portfolio cannot be reconfigured within such value range, then the entire portfolio can be converted into the security with the lowest beta, or the security with the best performance over a defined time horizon, or into cash.

In another example, an investment card is linked to General Motors, General Mills, Apple, and Sprint Nextel shares and is used to make a USD 1,000 purchase. The merchant will forward card data (e.g., cardholder name, unique customer number, card network, issuer, transaction amount, etc.) to the merchant bank. The merchant bank will then forward the card data to the card network (e.g., Visa), which in turn forwards it to the issuer. Once it authenticates the investment card, the issuer will perform a variety of functions, including using wallet algorithms to determine the order in which the wallet(s) on the investment card will be accessed and using payment algorithms to determine whether the cardholder has sufficient funds to pay for the transaction. Pursuant to issuer policies and regulatory requirements, the fees, commissions, costs, and/or taxes related to the sale of securities resulting from the cardholder's use of his investment card may be deducted from the cardholder's investment card at the time the cardholder makes a purchase. If so, the issuer may choose to apply the same wallet and payment algorithms for payment of such fees, commissions, costs, and/or taxes as he does for payment of the underlying purchase from the merchant. Similarly, if the merchant places a hold on the cardholder's investment card, the issuer may choose to apply the same wallet and payment algorithms for the amount of the hold; when the merchant releases its hold on the cardholder's investment card, the issuer will allow the cardholder access to those funds.

Rather than employing payment algorithms, the issuer may choose other alternatives upon successful completion of the fraud analysis of the investment card. For example, the issuer may choose to generate an authorization code and send it to the card network only after such time as the sale of securities linked to the investment card has been effectuated and/or such sales proceeds received. As in this case the issuer would wait until effectuating the trade and/or receiving the sale proceeds from such trade before issuing the authorization, there would be no need to apply the payment algorithm as the issuer would know precisely the amount of the net proceeds generated by the sale of the securities linked to the investment card that were sold to finance the cardholder's purchase from the merchant.

The cardholder may choose to link credit card(s), prepaid card(s), and/or debit card(s) accounts to the investment card; phrased differently, the cardholder may choose to link these different wallet types to his investment card in addition to the different wallets linked to securities. Furthermore, the issuer may approve purchases even though application of the wallet and payment algorithms to the investment card's securities wallets indicates there are insufficient authorized funds in the cardholder's security portfolio(s) to effectuate the purchase by accessing these different wallet types to compensate for any deficit (i.e., the difference between the purchase price and the authorized funds linked to the securities on the investment card).

In an example of linking a credit card account to the investment card, via application of the wallet and payment algorithms the issuer may conclude the funds in a given wallet (or all wallets) on the investment card linked to securities are insufficient to pay for a purchase. Nonetheless, the issuer may then access the credit card linked to the investment card to finance the difference between the purchase price and the amount of authorized funds linked to the securities wallet(s). Thus, if the purchase price were USD 1,000, and the application of the wallet and payment algorithms provided a maximum authorized funds linked to the securities wallet(s) of USD 800, then the issuer may approve the transaction and use the credit card component of the investment card to fund the deficit (USD 1,000−USD 800=) USD 200 amount. This deficit amount could be recalculated once the net proceeds from the sale of securities linked to the investment card were received, so that for example if the net proceeds from such sale were USD 830, then the credit charge would be recalculated to USD 170 (=USD 1,000−USD 830). In this case, the issuer may initially place a USD 200 hold on the credit card account linked to the investment card, and the hold amount would be recalculated to USD 170 once the net proceeds from the sale of securities linked to the investment card were known.

The above process can also be applied to prepaid card(s) and debit card(s) accounts linked to the investment card. In those cases, rather than accessing the credit card component of the investment card to finance the deficit amount, a prepaid or debit card account linked to the investment card would be accessed. Similar to the example above, an initial hold of USD 200 would be placed on the prepaid or debit card, and the hold amount recalculated once the net proceeds from the sale of securities linked to the investment card was known. The prepaid card and debit card linked to the investment card could be tied to cash, checking or savings accounts, cash or asset management accounts, margin accounts, or any other repository of funds. Therefore, even if the securities in the wallet(s) of the investment card are insufficient to effectuate the purchase, this deficit amount can be paid by accessing credit card(s), prepaid card(s), and/or debit card(s) accounts linked to the investment card.

If the cardholder chooses to link credit card(s), prepaid card(s), and/or debit card(s) accounts to the investment card, then a card hierarchy algorithm may be specified and applied to determine the order in which these accounts are accessed to pay for the deficit amount. This card hierarchy algorithm may take multiple forms. In one alternative, at the time of the transaction, the cardholder would specify at the point of sale whether he wants to use a credit card, prepaid card, or debit card account linked to his investment card to pay for the deficit amount (i.e., the amount remaining after the wallet(s) on the investment card are depleted). In another alternative, prior to the time of the transaction, the cardholder would go to a dedicated website and select the order in which he would like his credit card(s), prepaid card(s), and/or debit card(s) accounts linked to his investment card accessed to pay for any deficit amounts that may arise. In another alternative, a card hierarchy algorithm may determine how any deficit amounts that may arise should be paid. For example, a card hierarchy algorithm may specify that a prepaid card account will first be accessed to pay for any deficit amount. If there is no prepaid card account(s) linked to the investment card or if the amounts on the prepaid card are insufficient to pay for the deficit amount, then a debit card account will next be accessed to pay for any deficit amount. If there is no debit card account(s) linked to the investment card or if the amounts on the debit card are insufficient to pay for the deficit amount, then a credit card account will next be accessed to pay for any deficit amount. If the amount of authorized funds on the investment card linked to securities is insufficient, and the amounts on the prepaid/debit/credit card(s) linked to the investment card are insufficient to pay for the deficit amount, then the transaction would be declined.

Thus, as explained above, the cardholder may have either active or passive as well as ex ante or ex post alternatives for specifying whether and how he wants credit card(s), prepaid card(s), and/or debit card(s) accounts linked to his investment card accessed to pay for any deficit amounts. Furthermore, if the cardholder has multiple wallet types (e.g., prepaid, debit, and/or credit card) linked to his investment card, either actively or passively via algorithms the cardholder may determine whether to use a prepaid, debit, or credit card component instead of his investment card wallet(s), as the various wallet type(s) as well as the investment card can all be on the same piece of plastic or payment interface (e.g., smartphone, tablet, computer, or similar device). Indeed, such payment interfaces are well-suited to enabling the cardholder to specify both what wallet(s) (e.g., which securities portfolio) and what wallet type(s) to use to pay for a given transaction, as well as to reconfigure the algorithms that determine how a given transaction will be paid.

For example, assume the cardholder has a single credit card account and a single securities wallet (e.g., a single wallet comprised only of General Motors shares) linked to his investment card. Either actively at the time of the transaction or passively via pre-established card spending algorithms, the cardholder may select whether to access the credit card linked to his investment card or the securities wallet linked to that same investment card to pay for a given transaction. In the case where General Motors shares have increased in price by more than X percent in a defined time period, the cardholder may select (or the algorithm may specify) the securities wallet to pay for the purchase, as by so doing he is able to realize the increase in value of the underlying security. Similarly, if such shares have decreased in price by more than X percent in a defined time period, the cardholder may select to use the credit card component of his investment card to pay for the purchase, as by so doing he is able to maintain the investment in General Motors and avoid realizing a loss at the time of purchase from the merchant. Note that a cardholder may choose the opposite strategy, i.e., use the securities wallet at the time of purchase if the underlying shares are declining in value to avoid any further losses and use the credit card component at the time of purchase if the underlying shares are increasing in value to benefit from any further gains.

In another example, assume that the wallet algorithm—selected by the cardholder or the issuer—operated so that the wallet containing the worst performing security in terms of percentage gain/loss over a defined period of time (e.g., one week) were accessed first, the next worst performing security over that period of time were accessed next, etc. If the investment card contained a single wallet, then the wallet algorithm would automatically default to that single wallet. Further assume that at the time the cardholder presented his investment card to the merchant that during the preceding week General Motors shares performed worse than General Mills shares, which in turn performed worse than Apple shares, which in turn performed worse than Sprint Nextel shares. Further assume at the time the cardholder presented his investment card to the merchant that the respective opening share prices were USD 22.67 for General Motors, USD 39.29 for General Mills, USD 678.05 for Apple, and USD 4.92 for Sprint Nextel. Further assume that the multi-wallet investment cardholder had ten shares of each linked to his card. In this case, the issuer would apply the wallet algorithm to determine that the wallet containing the General Motors shares should be accessed first (i.e., making the wallet linked to General Motors shares the “first wallet”), as it is the worst performing wallet over the preceding week of all the wallets contained on the investment card.

Next, the issuer would apply the payment algorithm to the first wallet to determine the funds available value (FAV) of each share in the first wallet. Applying a conservative algorithm as follows: FAV≤(O)×(1−P), where FAV=the maximum funds authorized per share; O=the opening price of the underlying security (USD 22.67); and P=D/M (which in this case is (USD 4.48/USD 23.20)=19.31%), where M =the mean of the 52 week low/high ((the high and low stock price over the preceding 52 weeks) divided by 2), which in this case is ((USD 18.72+USD 27.68)/2)=USD 23.20; and where D=the differential between M and the 52 week low stock price, which in this case is (USD 23.20−USD 18.72=) USD 4.48.

Thus, in this example, the card issuer would apply the payment algorithm: FAV≤(USD 22.67)×(1−(USD 4.48/USD 23.20)), simplified as FAV≤(USD 22.67)×(0.8069), ≤USD 18.29 per share. Next, the issuer would multiply the FAV per share times N (which is the total number of shares per wallet) to obtain the total funds available for expenditure per wallet. As applied in this case, FAV*N=USD 18.29*10=USD 182.90, which is the total funds available for expenditure for the first wallet. Next, because USD 182.90 resulting from the application of the wallet and payment algorithms is less than the USD 1,000 purchase price, the application of the wallet algorithm would lead to accessing the second wallet, i.e., that containing General Mills stock. The payment algorithm would then be applied to the second wallet to determine the funds available for expenditure. Applying a conservative algorithm, as follows: FAV≤(O)×(1−P), where O=USD 39.29; and P=D/M, which in this case is (USD 2.23/USD 38.84)=5.74%; where M=((USD 36.61+USD 41.06)/2)=USD 38.84, and where D=(USD 38.84−USD 36.61)=USD 2.23. Thus, in this example, the card issuer would apply the payment algorithm: FAV≤(USD 39.29)×(1−(USD 2.23/USD 38.84)), simplified as FAV≤(USD 39.29)≤(0.9426), ≤USD 37.03 per share.

Next, the issuer would multiply the FAV per share times N to obtain the total funds available per wallet. As applied in this case, FAV*N=USD 37.03*10=USD 370.30, which is the total funds available for the second wallet. Next, the issuer would total the sum of funds available for purchase of Wallet 1 (USD 182.90) plus Wallet 2 (USD 370.30). Because such sum (USD 182.90+USD 370.30=553.20) is less than the USD 1,000 purchase price, the application of the wallet algorithm would lead to accessing the third wallet, i.e., that containing Apple shares. The issuer would then apply the payment algorithm to determine the funds available for expenditure. Applying the conservative algorithm as follows: FAV(O)×(1−P), where O=USD 678.05; and P=D/M, which in this case is (USD 57.47/USD 622.97)=90.78%, where M=((USD 565.50+USD 680.44)/2)=USD 622.97, and where D=(USD 622.97−USD 565.50)=USD 57.47. Thus, in this example, the card issuer would apply the payment algorithm: FAV≤678.05)×(1−(USD 57.47/USD 622.97)), simplified as FAV≤(USD 678.05)×(0.9078), ≤USD 615.53 per share.

Next, the issuer would multiply the FAV per share times N (which is the total number of shares per wallet) to obtain the total funds available per wallet. As applied in this case, FAV*N=USD 615.53*10=USD 6,155.30, which is the total funds available for the third wallet. Next, the issuer would total the sum of funds available for purchase of Wallet 1 (USD 182.90) plus Wallet 2 (USD 370.30) plus Wallet 3 (USD 6,155.30). Because such sum (USD 182.90+USD 370.30+USD 6,155.30=USD 6,708.50) is greater than the USD 1,000 purchase price, the application of the wallet and payment algorithms would determine there is no need to access the fourth wallet. Because the difference between the purchase price and the sum of Wallet 1 plus Wallet 2 is less than the FAV of a single share in Wallet 3−(USD 1,000−(USD 182.90+USD 370.30)=USD 446.70; USD 446.70<615.53)—then application of the wallet and payment algorithms would determine there is no need to access more than one share of Apple, and the remaining Apple shares in Wallet 3 would remain on the cardholder's investment card (while the first and second wallets would be fully depleted).

It can be seen that after all of the securities linked to Wallet 1 are sold, and all of the securities linked to Wallet 2 are sold, and one of the shares linked to Wallet 3 is sold, there are surplus funds to pay for the purchase ((USD 182.90+USD 370.30+USD 6,155.30)=USD 6,708.50; (USD 6,708.50−USD 1,000 purchase price)=USD 5,708.50 of surplus funds). These surplus funds can be allocated in multiple ways, such as by application of a surplus funds allocation algorithm or by placing such funds in the cash wallet of the investment card. Furthermore, the issuer may send a notification to the cardholder stating there are surplus funds left over from his purchase, and the issuer may notify the cardholder how those funds were allocated (e.g., pursuant to application of a surplus funds allocation algorithm) or place the surplus funds into the cash wallet until the cardholder specifies how he wants such surplus funds allocated.

Also, application of the conservative payment algorithm likely will also produce a positive balance of funds in the cardholder account in addition to the surplus funds referenced above. For example, by application of the conservative payment algorithm, FAV(1)—i.e., the maximum funds authorized for expenditure per share linked to Wallet 1—is USD 18.29; FAV(2) is USD 37.03; and FAV (3) is USD 615.53. Assume that the actual average selling price (AASP) per security linked to Wallet 1 was USD 20.63; to Wallet 2 was USD 34.28 (i.e., the actual average sale price was less than the FAV); and to Wallet 3 was USD 624.21. Therefore, the positive balance of funds per wallet equals ((AASP−FAV)*N)). As applied to this example, the positive balance of funds is: ((ASP (1)−FAV(1))*N)=(USD 20.63−USD 18.29)*10=USD 2.34*10=USD 23.40, plus ((ASP (2)−FAV(2))*N)=(USD 34.28−USD 37.03)*10=USD−2.75*10=USD−27.50, plus ((ASP (3)−FAV(3))*N)=(USD 624.21−USD 615.53)*1=USD 8.68*1=USD 8.68, so USD 23.40+(USD−27.50)+USD 8.68=USD 4.58. Phrased differently, the cumulative difference across the three wallets between the actual proceeds from the sale of the securities linked to the investment card and the a priori maximum funds authorized for expenditure is USD 4.58. The positive balance of funds can be allocated in multiple ways, such as by application of a surplus funds allocation algorithm or by placing such funds in the cash wallet of the investment card. Furthermore, the issuer may send a notification to the cardholder stating there is a positive balance of funds left over from his purchase, and the issuer may notify the cardholder how those funds were allocated (e.g., pursuant to application of a surplus funds algorithm) or place those funds into the cash wallet until the cardholder specifies how he wants such funds allocated.

Because the wallet and payment algorithms indicate the cardholder has sufficient funds available to effectuate the purchase, the issuer then generates an authorization code and sends it to the card network, which sends the authorization code to the merchant bank, which sends the authorization code to the merchant, which then concludes the sale with the cardholder. For example, see above discussion with regard to FIG. 3B and steps 364, 370, 372 and 374.

Examples of alerts or notifications regarding transactions may include email, text messages, or smart phone applications informing the cardholder of his authorized or declined purchases. Any relevant party, including the card issuer or the processor, may send these messages. Furthermore, the information contained in these messages may be hosted in a centralized database, on a cloud platform, or on a private database. For example, when a transaction is authorized, the cardholder may receive a communication stating the merchant, the purchase price, and the time and place of such transaction. In another example, if the currencies in which the investment card is denominated and the purchase is denominated are different, the communication may state the rate at which the purchase currency was converted into the investment card currency. Each time that the investment cardholder adds funds to his account, the communication may state the amount of funds added in the applicable currency, the securities purchased with such funds, the respective prices at which the securities were purchased, and the total shares purchased with such funds. In another example, each time the securities portfolio linked to the investment card is automatically or optionally reconfigured, the communication may state how the portfolio was reconfigured, what securities were purchased and/or sold, the purchase and/or sale amounts of such securities in the applicable currency, and the current portfolio configuration.

An example of a communication regarding the nominal value of the investment card and the funds available for expenditure on the investment card may include email, text messages, or smart phone applications informing the cardholder of such data. Furthermore, the information contained in these messages may be hosted in a centralized database, on a cloud platform, or on a private database. For example, at defined time intervals and/or on demand, the communication may state the nominal value of his portfolio and the funds available for expenditure. In another example, at defined time intervals and/or on demand, the communication may provide a portfolio update, stating the current portfolio configuration.

An example of a communication regarding the performance of the security linked to the investment card may include email, text messages, or smart phone applications informing the cardholder of such data. Such data may include information regarding different metrics such as absolute performance, relative performance, and beta of the security linked to the investment card. Furthermore, the information contained in these messages may be hosted in a centralized data base, on a cloud platform, or on a private database. For example, at defined time intervals and/or on demand, the communication may state the absolute and relative performance of securities linked to the investment card, and/or such communication may provide data regarding metrics such as beta, low/high prices for the security over a defined time period, percentage and absolute price change over a defined time period, as well as other metrics the relevant parties deem valuable. In another example, the communication may alert the relevant party that a security has moved outside a defined range for a given metric (e.g., beta), which in turn may trigger an automatic or optional portfolio reconfiguration. For example, the communication may alert the cardholder that the value of a given security has fallen below a defined threshold, in which case the holdings in said security may be automatically or optionally sold in full and the sale proceeds converted into another security and/or cash.

The messaging system can provide the investment cardholder with an array of data, including the purchase amount and confirmation, the nominal value of his account, and the funds available for expenditure (i.e., the percentage of the nominal account value that he can spend via his investment card). Furthermore, the messaging system can provide the investment cardholder with an array of data related to the performance of the security to which his card is linked, including whether the security has appreciated or depreciated by a set amount, whether the volatility of said security has departed from set parameters, whether the security holdings linked to his card have been automatically or optionally reconfigured to conform to set parameters, and whether the security linked to his card has been converted to cash.

Because the value of a security may be in a frequent state of flux, the value of the investment cardholder account may change rapidly. Consequently, given the value of a specific expenditure is constant but the securities needed to pay for that expenditure can increase or decrease over a given time interval, there is a need to ensure that once a transaction is authorized there are sufficient funds to make payment. This invention provides a system and method whereby the card issuer and/or transaction processor can establish algorithms regarding the relationship between the market value of the investment cardholder's account and funds he has available to spend, thereby significantly limiting the card issuer's exposure and risk.

Because any given security varies in price, at the time of authorization the investment cardholder may have sufficient funds to make a specific expenditure, but in the period between authorization and settlement the underlying security may decrease in value and therefore the investment cardholder may have insufficient funds to pay for said purchase at the time of settlement. For example, assume the investment cardholder has transferred USD 100 to the card issuer to obtain 10 shares of a stock whose then value is USD 10 per share. Assume the price increases to USD 11 per share, so that the investment cardholder has a nominal value of USD 110 in his account. Assume the investment cardholder makes a purchase for USD 105, and in the interval between his purchase and settlement the stock falls to USD 9 per share. There then is a shortfall between the amount of the authorized purchase (USD 105) and the market value of the account at the time of settlement (USD 90).

To solve the above problem, various embodiments of the invention provide systems, methods, tools and techniques wherein the relevant parties take real time data feeds regarding the market value of a given security and then apply a set of algorithms to determine what percentage of the market value in an investment cardholder's account is available for making authorized expenditures. An example of such an algorithm could tie the beta of the security linked to the investment card to a formula defining the ratio of authorized funds available for spending to the market value of the investment cardholder's portfolio.

For example, assume Cardholder Z's investment card is tied to the value of a volatile stock (therefore, one with a high beta such as 3) and Cardholder X's investment card is tied to the value of a major index such as the S&P 500 (therefore, one with a beta of 1). Given Cardholder Z and Cardholder X′s investment cards are linked to different securities, the card issuer could reasonably decide to allow Cardholder Z access to a smaller percentage of his nominal portfolio value than that of Cardholder X. For example, the card issuer could create algorithms by which cardholders with a beta of 1 are allowed to spend up to 95% of the nominal value of their portfolios, while cardholders with a beta of 3 are allowed to spend up to 85% of the nominal value of their portfolios on a rolling basis.

In such case, the algorithm applied by the card issuer would be: Available funds for expenditure=N−(N(B×P)), where, N is the nominal value of the security linked to the investment card; B is beta; and P is the applied spending parameter of 5%. So—as determined by algorithms which the card issuer may set—for Cardholder Z, assuming there is USD 100 in the account linked to the investment card, he would be able to spend USD 100−(USD 100(3×5%))=USD 100−USD 15=USD 85. Cardholder X, assuming that there is USD 100 in the account linked to his investment card, would be able to spend USD 100−(USD 100(1×5%))=USD 100−USD 5=USD 95.

In another example, on a given day Cardholder 1 loads USD 1,000 of funds onto his investment card and specifies such funds shall be used to purchase GM stock. On the same day, Cardholder 2 loads USD 3,000 of funds onto his investment card and specifies such funds shall be used to purchase GM stock. On the same day, Cardholder 3 makes a purchase of USD 50 with funds previously loaded on his investment card linked to GM stock. On the same day, Cardholder 4 transfers USD 2,000 of funds previously loaded on one wallet of his investment card linked to GM stock to another wallet on his investment card linked to British Telecom stock. Rather than the financial institution engaging in four separate trades of GM stock (two separate purchases and two separate sales of GM stock), the financial institution may internally cross the transactions: Aggregate Inflows−Aggregate Outflows=Net Amount of Single Trade, so that (USD 1,000+USD 3,000=USD 4,000)−(USD 50+USD 2,000=USD 2,050)=USD 1,950.

Thus, the financial institution uses the inflow of USD 4,000 to offset the outflows of USD 2,050, thereby financing the purchase of Cardholder 3 and the fund transfer of Cardholder 4 while moving their corresponding shares of GM to the accounts of Cardholder 1 and Cardholder 2 in the respective amounts. As the aggregate inflows exceed the aggregate outflows, the residual USD 1,950 is used to purchase more GM stock, and those shares will be allocated correspondingly to the accounts of Cardholders 1 and 2.

In a separate example, on a given day, Cardholder 1 loads USD 1,000 of funds onto his investment card and specifies such funds shall be used to purchase Sprint Nextel stock. On the same day, Cardholder 2 loads USD 3,000 of funds onto his investment card and specifies such funds shall be used to purchase Sprint Nextel stock. On the same day, Cardholder 3 makes a purchase of USD 50 with funds previously loaded on his investment card linked to Sprint Nextel stock. On the same day, Cardholder 4 transfers USD 6,000 of funds previously loaded on one wallet of his investment card linked to Sprint Nextel stock to another wallet on his investment card linked to British Telecom stock.

Rather than the financial institution engaging in four separate trades of Sprint Nextel stock (two separate purchases and two separate sales of Sprint Nextel stock), the financial institution would internally cross the transactions: Aggregate Inflows−Aggregate Outflows=Net Amount of Single Trade, so that (USD 1,000+USD 3,000=USD 4,000)−(USD 50+USD 6,000=USD 6,050)=USD−2,050. Thus, the financial institution uses the inflow of USD 4,000 to partially offset the outflows of USD 6,050, thereby partially paying the purchase of Cardholder 3 and the fund transfer of Cardholder 4 while moving their corresponding shares of Sprint Nextel to the accounts of Cardholder 1 and Cardholder 2 in the respective amounts. As the aggregate outflows exceed the aggregate inflows, the residual USD 2,050 of Sprint Nextel shares are sold to obtain the funds necessary to complete the paying of the purchase of Cardholder 3 and the fund transfer of Cardholder 4.

For example, if a given investment cardholder wants to create (or reload) an account with USD 1,000 of General Motor shares, and another investment cardholder with a card linked to General Motors shares spends USD 800 on a given purchase, the card issuer may choose to make a single trade for USD 200 (USD 1,000 load value−USD 800 of spend value) rather than execute a buy order for USD 1,000 of General Motors stock and a separate sell order for USD 800 of General Motors stock, thereby effectively crossing the trade among investment cardholders who have linked their cards to the same underlying security.

The examples presented herein are intended to illustrate potential and specific implementations of the present invention. It can be appreciated that the examples are intended primarily for purposes of illustration of the invention for those skilled in the art. No particular aspect or aspects of the examples are necessarily intended to limit the scope of the present invention. For example, no particular aspect or aspects of the examples of system architectures, user interface layouts, or screen displays described herein are necessarily intended to limit the scope of the invention.

It is to be understood that the figures and descriptions of the present invention have been simplified to illustrate elements that are relevant for a clear understanding of the present invention, while eliminating, for purposes of clarity, other elements. Those of ordinary skill in the art will recognize, however, that a sufficient understanding of the present invention can be gained by the present disclosure, and therefore, a more detailed description of such elements is not provided herein.

Any element expressed herein as a means for performing a specified function is intended to encompass any way of performing that function including, for example, a combination of elements that performs that function. Furthermore the invention, as may be defined by such means-plus-function claims, resides in the fact that the functionalities provided by the various recited means are combined and brought together in a manner as defined by the appended claims. Therefore, any means that can provide such functionalities may be considered equivalents to the means shown herein.

In various embodiments, modules or software can be used to practice certain aspects of the invention. For example, software-as-a-service (SaaS) models or application service provider (ASP) models may be employed as software application delivery models to communicate software applications to clients or other users. Such software applications can be downloaded through an Internet connection, for example, and operated either independently (e.g., downloaded to a laptop or desktop computer system) or through a third-party service provider (e.g., accessed through a third-party web site). In addition, cloud computing techniques may be employed in connection with various embodiments of the invention. In certain embodiments, a “module” may include software, firmware, hardware, or any reasonable combination thereof.

Moreover, the processes associated with the present embodiments may be executed by programmable equipment, such as computers. Software or other sets of instructions that may be employed to cause programmable equipment to execute the processes may be stored in any storage device, such as, for example, a computer system (non-volatile) memory, an optical disk, magnetic tape, or magnetic disk. Furthermore, some of the processes may be programmed when the computer system is manufactured or via a computer-readable memory medium.

It can also be appreciated that certain process aspects described herein may be performed using instructions stored on a computer-readable memory medium or media that direct a computer or computer system to perform process steps. A computer-readable medium may include, for example, memory devices such as diskettes, compact discs of both read-only and read/write varieties, optical disk drives, and hard disk drives. A computer-readable medium may also include memory storage that may be physical, virtual, permanent, temporary, semi-permanent and/or semi-temporary.

A “computer,” “computer system,” “computing apparatus,” “component,” or “computer processor” may be, for example and without limitation, a processor, microcomputer, minicomputer, server, mainframe, laptop, personal data assistant (PDA), wireless e-mail device, smart phone, mobile phone, electronic tablet, cellular phone, pager, processor, fax machine, scanner, or any other programmable device or computer apparatus configured to transmit, process, and/or receive data. Computer systems and computer-based devices disclosed herein may include memory for storing certain software applications used in obtaining, processing, and communicating information. It can be appreciated that such memory may be internal or external with respect to operation of the disclosed embodiments. The memory may also include any means for storing software, including a hard disk, an optical disk, floppy disk, ROM (read only memory), RAM (random access memory), PROM (programmable ROM), EEPROM (electrically erasable PROM) and/or other computer-readable memory media. In various embodiments, a “host,” “engine,” “loader,” “filter,” “platform,” or “component” may include various computers or computer systems, or may include a reasonable combination of software, firmware, and/or hardware.

In various embodiments of the present invention, a single component may be replaced by multiple components, and multiple components may be replaced by a single component, to perform a given function or functions. Except where such substitution would not be operative to practice embodiments of the present invention, such substitution is within the scope of the present invention. Any of the servers described herein, for example, may be replaced by a “server farm” or other grouping of networked servers (e.g., a group of server blades) that are located and configured for cooperative functions. It can be appreciated that a server farm may serve to distribute workload between/among individual components of the farm and may expedite computing processes by harnessing the collective and cooperative power of multiple servers. Such server farms may employ load-balancing software that accomplishes tasks such as, for example, tracking demand for processing power from different machines, prioritizing and scheduling tasks based on network demand, and/or providing backup contingency in the event of component failure or reduction in operability.

In general, it will be apparent to one of ordinary skill in the art that various embodiments described herein, or components or parts thereof, may be implemented in many different embodiments of software, firmware, and/or hardware, or modules thereof. The software code or specialized control hardware used to implement some of the present embodiments is not limiting of the present invention. For example, the embodiments described hereinabove may be implemented in computer software using any suitable computer programming language such as .NET, SQL, MySQL, or HTML using, for example, conventional or object-oriented techniques. Programming languages for computer software and other computer-implemented instructions may be translated into machine language by a compiler or an assembler before execution and/or may be translated directly at run time by an interpreter. Examples of assembly languages include ARM, MIPS, and x86; examples of high level languages include Ada, BASIC, C, C++, C#, COBOL, Fortran, Java, Lisp, Pascal, Object Pascal; and examples of scripting languages include Bourne script, JavaScript, Python, Ruby, PHP, and Perl. Various embodiments may be employed in a Lotus Notes environment, for example. Such software may be stored on any type of suitable computer-readable medium or media such as, for example, a magnetic or optical storage medium. Thus, the operation and behavior of the embodiments are described without specific reference to the actual software code or specialized hardware components. The absence of such specific references is feasible because it is clearly understood that artisans of ordinary skill would be able to design software and control hardware to implement the embodiments of the present invention based on the description herein with only a reasonable effort and without undue experimentation.

Various embodiments of the systems and methods described herein may employ one or more electronic computer networks to promote communication among different components, transfer data, or to share resources and information. Such computer networks can be classified according to the hardware and software technology that is used to interconnect the devices in the network, such as optical fiber, Ethernet, wireless LAN, HomePNA, power line communication or G.hn. The computer networks may also be embodied as one or more of the following types of networks: local area network (LAN); metropolitan area network (MAN); wide area network (WAN); virtual private network (VPN); storage area network (SAN); or global area network (GAN), among other network varieties.

For example, a WAN computer network may cover a broad area by linking communications across metropolitan, regional, or national boundaries. The network may use routers and/or public communication links. One type of data communication network may cover a relatively broad geographic area (e.g., city-to-city or country-to-country) which uses transmission facilities provided by common carriers, such as telephone service providers. In another example, a GAN computer network may support mobile communications across multiple wireless LANs or satellite networks. In another example, a VPN computer network may include links between nodes carried by open connections or virtual circuits in another network (e.g., the Internet) instead of by physical wires. The link-layer protocols of the VPN can be tunneled through the other network. One VPN application can promote secure communications through the Internet. The VPN can also be used to separately and securely conduct the traffic of different user communities over an underlying network. The VPN may provide users with the virtual experience of accessing the network through an IP address location other than the actual IP address which connects the access device to the network.

The computer network may be characterized based on functional relationships among the elements or components of the network, such as active networking, client-server, or peer-to-peer functional architecture. The computer network may be classified according to network topology, such as bus network, star network, ring network, mesh network, star-bus network, or hierarchical topology network, for example. The computer network may also be classified based on the method employed for data communication, such as digital and analog networks.

Embodiments of the methods and systems described herein may employ internetworking for connecting two or more distinct electronic computer networks or network segments through a common routing technology. The type of internetwork employed may depend on administration and/or participation in the internetwork. Non-limiting examples of internetworks include intranet, extranet, and Internet. Intranets and extranets may or may not have connections to the Internet. If connected to the Internet, the intranet or extranet may be protected with appropriate authentication technology or other security measures. As applied herein, an intranet can be a group of networks which employ Internet Protocol, web browsers and/or file transfer applications, under common control by an administrative entity. Such an administrative entity could restrict access to the intranet to only authorized users, for example, or another internal network of an organization or commercial entity. As applied herein, an extranet may include a network or internetwork generally limited to a primary organization or entity, but which also has limited connections to the networks of one or more other trusted organizations or entities (e.g., customers of an entity may be given access an intranet of the entity thereby creating an extranet).

Computer networks may include hardware elements to interconnect network nodes, such as network interface cards (NICs) or Ethernet cards, repeaters, bridges, hubs, switches, routers, and other like components. Such elements may be physically wired for communication and/or data connections may be provided with microwave links (e.g., IEEE 802.12) or fiber optics, for example. A network card, network adapter or NIC can be designed to allow computers to communicate over the computer network by providing physical access to a network and an addressing system through the use of MAC addresses, for example. A repeater can be embodied as an electronic device that receives and retransmits a communicated signal at a boosted power level to allow the signal to cover a telecommunication distance with reduced degradation. A network bridge can be configured to connect multiple network segments at the data link layer of a computer network while learning which addresses can be reached through which specific ports of the network. In the network, the bridge may associate a port with an address and then send traffic for that address only to that port. In various embodiments, local bridges may be employed to directly connect local area networks (LANs); remote bridges can be used to create a wide area network (WAN) link between LANs; and/or, wireless bridges can be used to connect LANs and/or to connect remote stations to LANs.

In various embodiments, a hub may be employed which contains multiple ports. For example, when a data packet arrives at one port of a hub, the packet can be copied unmodified to all ports of the hub for transmission. A network switch or other devices that forward and filter OSI layer 2 datagrams between ports based on MAC addresses in data packets can also be used. A switch can possess multiple ports, such that most of the network is connected directly to the switch, or another switch that is in turn connected to a switch. The term “switch” can also include routers and bridges, as well as other devices that distribute data traffic by application content (e.g., a Web URL identifier). Switches may operate at one or more OSI model layers, including physical, data link, network, or transport (i.e., end-to-end). A device that operates simultaneously at more than one of these layers can be considered a multilayer switch. In certain embodiments, routers or other like networking devices may be used to forward data packets between networks using headers and forwarding tables to determine an optimum path through which to transmit the packets.

As employed herein, an application server may be a server that hosts an API to expose business logic and business processes for use by other applications. Examples of application servers include J2EE or Java EE 5 application servers including WebSphere Application Server. Other examples include WebSphere Application Server Community Edition (IBM), Sybase Enterprise Application Server (Sybase Inc), WebLogic Server (BEA), JBoss (Red Hat), JRun (Adobe Systems), Apache Geronimo (Apache Software Foundation), Oracle OC4J (Oracle Corporation), Sun Java System Application Server (Sun Microsystems), and SAP Netweaver AS (ABAP/Java). Also, application servers may be provided in accordance with the .NET framework, including the Windows Communication Foundation, .NET Remoting, ADO.NET, and ASP.NET among several other components. For example, a Java Server Page (JSP) is a servlet that executes in a web container which is functionally equivalent to CGI scripts. JSPs can be used to create HTML pages by embedding references to the server logic within the page. The application servers may mainly serve web-based applications, while other servers can perform as session initiation protocol servers, for instance, or work with telephony networks. Specifications for enterprise application integration and service-oriented architecture can be designed to connect many different computer network elements. Such specifications include Business Application Programming Interface, Web Services Interoperability, and Java EE Connector Architecture.

In various embodiments, computers and computer systems described herein may have the following main components: arithmetic and logic unit (ALU), control unit, memory, and input and output devices (I/O devices). These components can be interconnected by busses, often comprising groups of wires or cables. The control unit, ALU, registers, and basic I/O (and often other hardware closely linked with these sections) can be collectively considered a central processing unit (CPU) for the computer system. The CPU may be constructed on a single integrated circuit or microprocessor.

The control unit (control system or central controller) directs the various components of a computer system. The control system decodes each instruction in a computer program and turns it into a series of control signals that operate other components of the computer system. To enhance performance or efficiency of operation, the control system may alter the order of instructions. One component of the control unit is the program counter, a memory register that tracks the location in memory from which the next instruction is to be read.

The ALU is capable of performing arithmetic and logic operations. The set of arithmetic operations that a particular ALU supports may be limited to adding and subtracting or might include multiplying or dividing, trigonometry functions (sine, cosine, etc.) and square roots. Some may be programmed to operate on whole numbers (integers), while others use floating point to represent real numbers, for example. An ALU may also compare numbers and return Boolean truth values (e.g., true or false). Superscalar computers may contain multiple ALUs to facilitate processing multiple instructions at the same time. For example, graphics processors and computers with SIMD and MIMD features often possess ALUs that can perform arithmetic operations on vectors and matrices. Certain computer systems may include one or more RAM cache memories configured to move more frequently needed data into the cache automatically.

Embodiments of the methods and systems described herein may divide functions between separate CPUs, creating a multiprocessing configuration. For example, multiprocessor and multi-core (multiple CPUs on a single integrated circuit) computer systems with co-processing capabilities may be employed. Also, multitasking may be employed as a computer processing technique to handle simultaneous execution of multiple computer programs.

In various embodiments, the computer systems, data storage media, or modules described herein may be configured and/or programmed to include one or more of the above-described electronic, computer-based elements and components, or computer architecture. In addition, these elements and components may be particularly configured to execute the various rules, algorithms, programs, processes, and method steps described herein.

While various embodiments of the invention have been described herein, it should be apparent, however, that various modifications, alterations and adaptations to those embodiments may occur to persons skilled in the art with the attainment of some or all of the advantages of the present invention. The disclosed embodiments are therefore intended to include all such modifications, alterations and adaptations without departing from the scope and spirit of the present invention as described herein.

1-118. (canceled)

119. An improved electronic card payment system, comprising:
a card medium associated with an investment card account of a cardholder, wherein the investment card account is issued by an issuer to the cardholder, and wherein the investment card account is associated with at least first and second wallets of the cardholder, wherein the first wallet comprises an investment account wallet of the cardholder that is backed by financial securities held by the cardholder in an investment account and the second wallet comprises a cash account wallet backed by cash held by the cardholder;
a merchant card payment system that is in communication with an electronic card payment network, wherein the merchant card payment system is for:
receiving payment information from the card medium for an intended purchase to be made by the cardholder with the card medium; and
upon receiving the payment information, transmitting, via the electronic card payment network, data about the intended purchase, wherein the data comprises a purchase price for the intended purchase; and
an issuer computing system of the issuer, wherein the issuer computing system is for:
receiving, via the card network, the data about the intended purchase with the card medium;
upon receiving the data about the intended purchase, applying a hierarchical wallet payment algorithm to determine:
a sequence in which the first and second wallets will be accessed to pay for the purchase;
upon a determination, based on the sequence, that the first wallet is to fund an investment account payment amount that is, in part or in whole, the purchase price for the intended purchase, whether there are sufficient funds in the first wallet for the investment account payment amount, wherein determining whether there are sufficient funds in the first wallet for the investment account payment amount comprises determining funds available from the first wallet based on a transaction value of the financial securities backing the first wallet, wherein the transaction value of the financial securities is a function of, and less than, a market value of the financial securities,
upon a determination that there are sufficient funds in the first and second wallets of the cardholder to make the purchase, including sufficient funds in the first wallet to make the investment account payment amount:
sending an authorization code to the merchant card payment system via the electronic card payment network that the purchase is authorized; and
upon a determination pursuant to the hierarchical wallet payment algorithm that the funds for the purchase are to be paid, at least in part, from the wallet, determining, using a transactions valuation algorithm, a number of shares of the financial securities in the investment account to be redeemed in order to cover the investment account payment amount from the first wallet.

120. The improved electronic card payment system of claim 119, wherein the card medium comprises a tangible plastic card.

121. The improved electronic card payment system of claim 119, wherein the card medium comprises a mobile computing device that wirelessly transmits card data.

122. The improved electronic card payment system of claim 119, wherein determining the funds available from the first wallet comprises determining a percentage, less than 100%, of a market value of the securities held in the investment account.

123. The improved electronic card payment system of claim 119, wherein:
the financial securities backing the investment account wallet are of the same type and from the same issuer; and
determining the funds available from the first wallet is additionally based on a performance metric of the financial securities.

124. The improved electronic card payment system of claim 123, wherein the performance metric is a volatility metric of the financial securities.

125. The improved electronic payment system of claim 119, wherein the investment account consists of at least one share of a first security, and wherein the transactions valuation algorithm comprises:
determining, by the issuer computing system, that the purchase price does not evenly divide into a share value of the first security; and
determining, by the issuer computing system, a remainder of the purchase price to be funded from the second wallet, wherein the remainder of the purchase price is an amount of the purchase price that does not divide evenly into the share value of the first security.
